(19) United States
(12) Patent Application Publication
(10) Pub. No.: US 2015/0123787 A1
(43) Pub. Date: May 7, 2015

(54) CENTRALLY MANAGED LONE WORKER MONITORING SYSTEM AND METHOD

(71) Applicant: SASKATCHEWAN TELECOMMUNICATIONS, Regina (CA)

(72) Inventors: Brent Watson, Regina (CA); Dave Bailey, Regina (CA)

(21) Appl. No.: 14/531,328

(22) Filed: Nov. 3, 2014

(30) Foreign Application Priority Data
Nov. 1, 2013 (CA) 2832062

(51) Int. Cl. G08B 21/02; G06Q 10/06

(52) U.S. Cl. CPC G08B 21/02; G06Q 10/06
USPC 340/539.13

(57) ABSTRACT

A method for the central monitoring and management of safety and location functions for lone workers is provided. A lone worker monitoring profile is created in a monitoring database on a monitoring server including a designation of periodic check-in frequency. Periodic remote check-ins are requested from the monitoring server to the clients. In addition to the remote check-ins, periodic sensor data is captured to the monitoring database, as well as immediate notification when immediate alert conditions are detected on the client devices. The monitoring software on the monitoring server monitors data in respect of monitored devices, and where safety exceptions are detected a notification is generated via the user interface or interface of the monitoring server. Administration of the system including provisioning client devices on the system is all done via the monitoring server as well.

### CROSS-REFERENCE TO RELATED APPLICATIONS

This application claims priority to Canadian patent application No. 2832062 filed on Nov. 1, 2013, the entire contents of which are hereby incorporated by reference herein.

### FIELD OF THE INVENTION

This invention is in the field of safety monitoring applications for use by enterprises with remote or lone workers in dangerous work environments, and more particularly is in the field of centrally administered information systems for lone worker safety monitoring.

### BACKGROUND

There are many industrial and commercial environments in which it is desired to be able to monitor the well-being, location and other safety conditions of workers—from the remote or lone worker in a large local work complex, through to the far flung distribution of employees such as mechanics, repair technicians or distal locations where production workers are used or deployed. It is often time desirable to ensure that a worker is still all right by ensuring that they are still moving or active etc. Having a worker quickly just check in with an “all okay” indication, versus having them need to call in for a detailed oral interaction with the central monitoring station, is desirable—conversely where a predetermined schedule for these types of check-ins is established and the lone workers or remote workers feedback is not received, the situation can be escalated for further monitoring or investigation to ensure that the worker is okay.

In the past there have been many ways of remote work monitoring used. In the most conventional sense, remote workers might have in the past been required to physically check in from time to time with their supervisors or the like to indicate their work status or safety.

Alternatively in further distributed environments, employees might have needed for example to use or travel to a telephone to call in and report their status.

In conventional physical check-in scenarios, where lone workers might have needed to travel to a nearby telephone or to travel physically to a reporting in location, there was significant economic handicap to this geographic limitation. Particularly in more distributed work environments or industrial installations, the simple requirement to travel to a check-in location could not only represent a significant time, labor and resource cost for the company, but the act of moving to the check-in location itself may have represented an undue risk profile insofar as it would occasion the need for example for multiple movements through the installation etc. As such in these conventional physical check-in environments there have over the last number of years developed numerous different approaches to overcoming the need for a physical check-in, either by way of traveler movement to a check-in or muster point or the need to physically telephone in to report to a safety monitoring station etc.

Some of the early stage technical approaches which were tried, and may still be available in terms of providing the ability for remote lone worker monitoring or check-in in distributed industrial installations included the development and deployment of proprietary hardware and software, as well as a proprietary or separate communications network, which would be used for this purpose. For example, U.S. Pat. No. 4,906,972, from 1990, shows the implementation of a base station within a commercial installation which was capable of communicating with one or more remote units carried by workers within radio communication or network range of the base station or stations. Limitations of this type of a system include the fact that the use of a local or proprietary radio network limits the applicability or use of the system to “local area” versus “wide-area” or distributed applications, since the base stations would need to be wired together or otherwise configured to communicate with each other if a wider deployment of that type of the system was desired. In addition, the deployment of completely custom hardware in this type of a method would result in it being very expensive and as such would limit the commercial practicability of the system.

Other variations on lone worker or remote monitoring systems have been tried in the prior art, which use available public communication networks in place of a proprietary data network to communicate between a base station and one or more remote worker monitoring devices. For example the available public data network which is now in place ubiquitously throughout the marketplace in all but the most remote locations by virtue of the widespread adoption and use of smart phones and similar devices is a desirable communication framework for use in a method such as is disclosed herein.

There have been a number of patents previously issued or filed, which are publicly available at this time, which contemplate the use of the public data network in a remote check-in application and specifically contemplate the use of a smart phone or similar device as the client device which would be used to effect a remote check in. These include U.S. Pat. Nos. 7,629,891 and 7,911,334. However the limitations of the methods contemplated by those references include the fact that they contemplate the use of the public data network to effect a dispatch and receipt of remote reporting message directly between two client devices are smart phones, rather than between necessarily always the device of the client or remote individual and the central station. As well, those methods all seem to contemplate the creation and administration of any necessary central parameters or profile information by the lone worker of the client device—the lone worker could adjust the settings as required and generally speaking maintain personal control over their interaction with the systems of those inventions.

From a corporate or enterprise lone worker monitoring perspective, while these various attempts in the prior art represent indications of an opportunity in the marketplace, they each also exhibit some limitations which would limit their usefulness from an enterprise perspective. It is believed that a lone worker or remote worker monitoring system and method which dealt with some of these latent issues and limitations would be useful from a enterprise perspective and it is specifically contemplated that the majority of the required changes could be made by modifications to the central apparatus and software used in the method rather than the need for deployment of a very complex lone worker device monitoring software 20 to the smart phones or lone worker devices of the remote or lone workers to be monitored.

A first limitation of prior art attempts, and opportunity which it is believed would render a lone worker monitoring system more useful in an enterprise environment would be the deployment of a user interface of the server through which the company could provision, administer and monitor the devices of individual workers. Allowing individual lone workers to customize or configure their settings on a remote monitoring system would not be sufficient in terms of particularity or detailed periodic monitoring, either from a worker safety or from even a regulatory reporting perspective, and as such it would be desirable, it is believed, in a corporate environment, to use a remote monitoring system which did not allow the individual lone workers being monitored to adjust the monitoring parameters. Monitoring parameters as well as security escalation conditions or workflow etc. should only be controllable from the user interface of the server rather than by the lone worker, if the system is to gain the widest corporate acceptance as a monitoring and reporting tool.

Additionally, while most of the prior art methods examined allow for the capture of and interaction with the remote lone worker—either in some cases by the automated capture her feedback to a central station of movement data from a proprietary or purposely incorporated sensor, it is believed that actually physically prompting a remote or lone worker at their client device to require them to provide a physical interaction for recordal back to the central enterprise platform is the better way to execute this type of a system, since the requirement for a physical interaction from a compliance or recordkeeping perspective would provide the most robust data in so far as the check in from a lone worker or remote worker would be required to be a physical interaction rather than some kind of an automatically captured data point from the device inferring movement or the like.

From an enterprise reporting and data capture perspective it would also be desirable to capture and record the periodic location of remote workers, so that their paths of work can be confirmed either from a safety or workflow perspective. Capturing and logging the GPS coordinates of remote workers from their client devices, such that from a reporting or mapping perspective additional central monitoring or reporting could be done, is an additional function which would be desirable from an enterprise perspective in lone worker monitoring applications and which has not been done in conjunction with remote check in applications.

Additional types of personal risks can also be inferred using additional sensor data along with the locational position of the client device. For example ceased movement of a lone worker can be inferred by the comparison of captured location coordinates, or a fall could even be detected based upon gyroscope or accelerometer sensor data captured from the client device and reported back to a central monitoring station—the ability to monitor these additional types of safety threats in addition to requiring occasional physical check ends, would provide additional safety for the lone worker as well as the company who could upon detection of these additional events by the capture and use of additional data from a client device on a periodic and automated basis identify situations for follow-up or escalation more quickly. Again also from an enterprise perspective it is contemplated that the capture of this type of data to a reporting system might be useful in environments or industries where significant regulatory oversight was required or there were heightened safety reporting requirements.

### SUMMARY OF THE INVENTION

As outlined above, the present invention is a method of central monitoring and management of safety and location functions and check-ins for lone workers. It provides an enhanced means of monitoring the safety of workers in remote locations and providing feedback to a central monitoring location regarding locations or status of those lone workers via their smart devices.

The invention, a method of lone worker monitoring which uses a monitoring server operatively connected for two-way communication via a data network with a plurality of locationally aware mobile client devices. Each client device corresponds to a lone worker. The method is accomplished by first providing a monitoring database which is connected to the monitoring server. The monitoring database contains a lone worker monitoring profile for each lone worker which is desired to monitor. The lone worker monitoring profile which is stored with respect to a lone worker who it is desired to monitor in accordance with the method of the present invention, in the monitoring database, includes the identification particulars of that lone worker and an associated client device which would be the remote means of monitoring the lone worker in accordance with the remainder of the invention. The client device would be a smart device, cell phone or other similar device which is locationally aware and capable of running the necessary software and participating in the remainder of the method. In addition to the identification of the lone worker and the associated client device, the lone worker monitoring profile would also include an indication of a designated remote check-in frequency which was desired in respect to that particular lone worker and their client device. In certain embodiments or deployments of the system of the present invention, the same remote check-in frequency might be desired to be used for every lone worker and client device pairing, although in other cases it might be possible that it was desirable to adjust the remote check-in frequency per user or per profile. In some cases, in addition to the desire to set a periodic frequency on a designated remote check-in frequency it might also be desired to randomize the remote check-in frequency and a randomized remote check-in frequency is also contemplated within the scope of the present invention.

In addition to the designated remote check-in frequency, the lone worker monitoring profile for each lone worker would also include details of any periodic sensor stream data which were to be captured on their client device for storage in respect to the associated client device and the profile. Various types of periodic sensor data samplings, obtained from various input-output devices or sensors and available environmental parameters in relation to the client device, could be transmitted for storage or monitoring in accordance with the present invention. The periodic sensor data stream information might also include periodic snapshots of location coordinates or movement of the device which could be used for logging purposes, or for other purposes including geofencing.

In addition to periodic sensor stream data to be captured, as well as any periodic sensor stream parameters in respect to the sensor stream data to be captured in respect of a particular lone worker and client device pairing—which would allow for detection of departure from desirable periodic sensor stream ranges which would result in notification to the operator of the monitoring server, the lone worker monitoring profile would also include the details of any immediate alert conditions which should be detected by the associated client device and upon detection of the existence of any such immediate notification conditions should be transmitted to the monitoring server.

As will be discussed elsewhere herein, various types of periodic sensor stream data could be captured, dependent upon the different types of safety monitors or safety conditions that it was desired to try to monitor in accordance with the remainder of the present invention and also to provide periodic sensor readings and the like are contemplated within the scope of the present invention. It may also be the case that periodic sensor stream data was only transmitted for storage to the monitoring server if it measured in a particular acceptable or unacceptable range or parameters stipulated in the lone worker monitoring profile—for example it may be the case that the lone worker monitoring profile in respect of a particularly lone worker stipulated that location or accelerometer data should only be periodically transmitted if it exceeded particular geo fences or safety ranges, for the particular purpose of minimizing and optimizing data transmission and consumption by the client device.

The immediate alert conditions which might be desired to be notified and sensed by the associated client device could be many different types of conditions. If an immediate alert condition such as a safety threatening occurrence or the like was determined by the client device to exist it would be immediately transmitted to the monitoring server for storage and association with the associated lone worker monitoring profile and for further sensing, handling or notification in accordance with the remainder of the method of the present invention. Immediate alert conditions might include the detection of a fault-based accelerometer reading on the device, triggering of a manual safety requirement or “emergency button” by the lone worker, or other types of measurements or parameters which could be captured or understood based on contemporaneous sensor data or other readings from the input or output hardware associated with the client device. Additional information can also be stored in the lone worker monitoring profile with respect to a particular lone worker and client device pairing, for use in the practice of the remainder of the method of the present invention.

In addition to the monitoring database, lone worker device monitoring software would be provided for installation on each client device. That software, in communication with the monitoring server and the monitoring database by the network, would be capable of accessing and interacting with the lone worker monitoring profile of the particular client device and lone worker pairing in question, transmitting remote check-in communications from the client device to the monitoring server as required based on the remote check-in frequency, capturing periodic sensor stream data on the client device identified in the corresponding lone worker monitoring profile and transmitting that to the monitoring server periodically for storage, as well as detecting the existence of any immediate alert conditions identified in the associated lone worker monitoring profile and transmitting notification of the same to the monitoring server. Each transmission from the client device to the monitoring server would include the location coordinates of the client device.

The lone worker device monitoring software installed on the client device would interface with the input-output hardware of the client device to provide a transmission of indicating presence or a check in to the server, as might be required from time to time in accordance with the designated periodic remote check-in frequency. As outlined elsewhere herein upon occurrence or detection of the arrival of the designated remote check-in time associated with a lone worker monitoring profile, the monitoring server and its attendant software components would be capable of receiving a transmission of a remote check-in transmission or communication from a client device and storing that in relation to the profile in question. Physical check in by the client device could take many forms—a manual check in could be required to be triggered by the user, by entry of a password or some other manual interface interaction, or the device could automatically transmit a communication.

Based upon the parameters outlined in the corresponding lone worker monitoring profile, the lone worker device monitoring software would also capture periodic sensor stream data on the client device and transmit that back to the monitoring server for storage in association with the associated lone worker monitoring profile—for logging, recordal or monitoring purposes. As well, if the lone worker device monitoring software in conjunction with the remainder of the hardware and software components on the client device detected the occurrence of any identified immediate alert condition outlined in the profile on the monitoring server, that would be transmitted immediately as well for storage and associated with the associated lone worker monitoring profile and for potential escalation and notification in accordance with the remainder of the method.

In addition to the lone worker device monitoring software on the client devices there would also be console software provided on the monitoring server which was operatively connected to the monitoring database which would in conjunction with a user interface of the monitoring server allow for the creation and modification of lone worker monitoring profiles in the monitoring database with respect to particular pairings of workers and client devices. Provisioning and maintenance of lone worker monitoring profiles in the monitoring database would only be permitted from the monitoring server backend and would not be adjustable by the lone worker's individual or for individually or from their client device.

The console software on the monitoring server would also upon arrival of predetermined check-in frequencies monitor in certain embodiments the receipt of communications from client devices to ensure that they were checking in appropriately.

The console software on the monitoring server would also capture periodic sensor stream data and any detected immediate alert condition data transmitted from client devices and would store that also in the monitoring database, or a related data structure, in conjunction with the associated lone worker profiles.

The console software on the monitoring server would also receive client data transmissions from client devices on the network and store the details of those client data transmissions in the monitoring database in association with their corresponding lone worker monitoring profile, including remote check-in communications, periodic sensor stream data transmissions, or immediate alert condition notifications.

During operation of the monitoring method of the present invention, the console software and remaining components would operate a lone worker monitoring loop, which would scan the remote check-in communications stored within the stored client device data in the monitoring database to detect any failure of a client device to transmit a lone worker check in within the designated remote check-in frequency in the corresponding profile and upon detection of any such failure provide an alert to the user interface of the monitoring server. In addition to seeking to detect failure to conduct an appropriate remote check in, it would also scan periodic sensor stream data stored within the stored client device data in the monitoring database to detect any departure of any of the periodic sensor stream data in respect of their respective client devices from any periodic sensor stream parameters stored within the lone worker monitoring core profile corresponding thereto and upon detection of any such departure provide an alert to the user interface of the monitoring server. Finally and as importantly, the console software would also scan the stored client device data in the monitoring database for any immediate alert condition notifications in respect to the monitored client device and upon detection of any previously unnotified immediate alert condition notifications they would provide an alert to the operator of the user interface of the monitoring server.

The user interface of the monitoring server would either be a hardware interface such as a keyboard and monitor attached to the monitoring server at a central monitoring station of the present invention, or might also comprise another remote browser interface of the like. It is key however for the present invention that the user interface of the monitoring server would not be maintained or accessed on an ongoing basis by the lone workers themselves from their client devices and rather it would only be done at an enterprise level by monitoring personnel. This maximizes the security and integrity of data stored within the system as well as the safety of lone workers being monitored thereby.

Certain implementations of the lone worker device monitoring software on the client devices would also be programmed in such a way that they could provide a “trouble indicator” function—whereby the lone worker who was associated with that client device could effectively press a panic button interface on the software which would be transmitted back to the monitoring server as a detected or detectable immediate alert condition for handling and notification.

In certain embodiments of the method of the present invention, where a notification was made to the user interface of the monitoring server, communication could be initiated between the monitoring server and the related client device—that is to say if a problem was detected from a client device and notified to the console of the server, the server could open a communication channel, including an audio communication channel where the components were hardware capable, back to the client device allowing for the operator at the central monitoring station to converse and generally speaking conduct troubleshooting or other protocols with the lone worker in question.

The periodic sensor stream data which was captured from at least one of the client devices could include the battery power level of the client device.

In addition to requiring a timely response in terms of remote check ins and a remote check-in frequency, the method could also incorporate monitoring for the detection of cessation of movement by a client device. Monitoring the cessation of movement by a client device could either be done by the lone worker client device monitoring software installed on the client device or by the monitoring software at the monitoring server. Detection of a stoppage of the movement of a client device, in addition to a failure to respond to a remote check-in request or frequency, would be the second of three key parameters which could in most circumstances be measured.

Another parameter which would be measured in most implementations of the method of the present invention would be to monitor the inputs and environmental variables which could be acquired from the client device hardware to ascertain if a fall or abrupt movement had taken place. Based upon a detection algorithm, a fall of the client device can be detected by accelerometer or gyroscope sensor readings, et cetera—this parameter could again be possible to be measured as a monitoring or a server side assessment of periodic sensor data steam information although it is more likely that detection of a fall or abrupt movement of the device would be characterized as an immediate alert condition assessment programmed into the lone worker device monitoring software for installation and operation on the client device itself.

In terms of remote check-in communications they could be transmitted from a client device to the monitoring server based on a preset frequency, or there could be other embodiments of the method of the present invention where remote check-in communications were transmitted from the client device to the monitoring server in response to a network request from the monitoring server to send such a communication. Both such approached to remote check-in frequency are contemplated within the scope hereof.

The immediate alert conditions which are stored in respect to the lone worker monitoring profile and the existence of which should be detected and notified to the monitoring server could at least be one or more of the following:
a. A fall of the client device.
b. Abrupt movement of the client device.
c. Cessation of movement of the client device and
d. Movement of the client device outside of a predefined working area.

Cessation of movement of the client device is determined by either comparing chronologically adjacent location coordinate and timestamp bearings, to determine a lack of movement, or alternatively determining that accelerometer readings from the client device indicate no movement. Both such approaches are contemplated within the scope hereof. The fall or abrupt movement of the client device is determined by detection of rapid movement by the accelerometer on the client device.

In terms of monitoring the movement of a client device outside of a predefined safety or working area, that can be determined by comparison of the location coordinates captured in respect of each transmission from the client device with one or more geo fences associated with the associated lone worker monitoring profile stored within or in relation to the database.

The operator of the monitoring service can send messages to the user interface or one or more of one or more of the client devices during the lone worker monitoring loop and certain embodiments.

The method of the present invention also comprises a computer implemented method of lone worker monitoring, which in a first step comprises providing a monitoring database which can be administered from a user interface of a central monitoring server. The database contains at least one lone worker monitoring profile associated with the lone worker to be monitored and the corresponding locationally aware client device. The lone worker monitoring profile contains at least identification of the lone worker and the associated client device, a designated remote check-in frequency for the associated client device, details of periodic sensor stream data, if any, to be captured and stored in respect to the associated client device along with periodic sensor stream parameters the detection of the departure from which should result in notification to the operator of the monitoring server, and details of immediate alert conditions which should be detected by the associated client device, upon detection of the existence of which immediate notification should be transmitted to the monitoring server. Every transmission from a client device to the monitoring server would include the location coordinates of the client device.

In support of this method to be executed on the server, on a client device corresponding to a lone worker monitoring profile detection of the arrival of the designated remote check-in frequency and transmission of a remote check-in communication to the server for storage in association with the lone worker monitoring profile corresponding thereto could be instigated. As well, on a client device corresponding to a lone worker monitoring profile, the periodic sensor stream data could be captured and transmitted to the monitoring server for storage again in association with the related lone worker monitoring profile. Finally, the immediate alert conditions of interest could be stored or programmed into the client device corresponding to a lone worker monitoring profile and upon detection of the existence of any immediate alert conditions contained within that corresponding lone worker monitoring profile that could be transmitted from the client device of the monitoring server for storage in association with the related lone worker monitoring profile.

Using monitoring software on the central monitoring server, the details of stored client device data stored in the monitoring database in relation to various of the lone worker monitoring profiles could be undertaken and upon detection of any of the following conditions, notification of the operator via the user interface of the monitoring server could be initiated:
a. Failure of a client device to respond to provide a timely remote check-in communication;
b. Detection of any previously unnotified immediate alert condition at a client device or
c. Detection of the departure of any periodic sensor stream data received from a client device from any periodic sensor stream data parameters specified in the associated lone worker monitoring profile.

As outlined above, various types of immediate alert conditions could be monitored and could be stored in respect of a particular lone worker monitoring profile, including for example detection of the fall of the client device associated with a lone worker, detection of abrupt movement of the client device, detection of cessation of movement of the client device, or detection of movement of the client device outside of predefined working area.

By capturing all of the various sensor data, safety parameters and data outlined herein from client devices paired with lone workers to the monitoring database for historical purposes, a reporting interface and the like could also be provided which would add additional value at the enterprise level to this type of a system.

The invention also comprises a monitoring server capable of two-way communication with the plurality of locationally aware mobile client devices of lone workers over a data network, wherein the monitoring server is operatively connected to a monitoring database containing a plurality of lone worker monitoring profiles each associated with the client device of a monitored lone worker in association or as outlined elsewhere herein. The lone worker monitoring profiles for each pairing of a lone worker and client device would include again identification of the worker and their client device, a designated remote check-in frequency, details of immediate alert conditions to be sensed or detected by the associated client device for notifications of the server, as well details and parameters of periodic sensor stream data in respect to the client device to be captured and transmitted to the server for archival or monitoring purposes.

In addition to being operatively connected to or hosting the monitoring database the monitoring server would also include a console software program adapted to be executed by the monitoring server to continuously scan the lone worker monitoring profiles stored within the monitoring database and the stored client device data stored from capture from the various client devices to detect notification conditions in terms of immediate risk conditions, or periodic sensor stream data exceptions. In any case where there was to be an exception or notification initiated, that would be initiated to the user interface of the server at the center of the system, and the central monitoring station could then follow up with the user in further detail.

The user interface of the server would be capable of creating and administering the lone worker monitoring profiles in the monitoring database. Only the central console or interface of the server would be able to administer the lone worker monitoring profiles in the database—lone workers themselves, either from remote devices or otherwise could, could not administer their own profiles.

### DESCRIPTION OF THE DRAWINGS

Selected embodiments of the present invention will now be described with reference to the accompanying drawings. In the accompanying drawings:

FIG. 1 shows an illustrative architecture for lone worker monitoring in accordance with the present invention;

FIG. 2 shows the client device of FIG. 1 in greater detail;

FIG. 3 shows the monitoring server of FIG. 1 in greater detail;

FIG. 4 shows the monitoring database of FIG. 1 in greater detail;

FIG. 5 is a flowchart showing one embodiment of the remote check-in and monitoring method of the present invention;

FIG. 6A is a representative screenshot from one embodiment of the user interface of the server of the present invention, through which a user could view and administer the lone worker monitoring profiles stored within the monitoring database;

FIG. 6B is a representative screenshot from one embodiment of the user interface of the server of the present invention, showing a user interface screen through which the user can administer parameters related to a particular lone worker in relation to a lone worker monitoring profile for the remainder of the system;

FIG. 6C is a representative screenshot from one embodiment of the user interface of the server of the present invention, showing a user interface screen through which the user can administer parameters in the lone worker monitoring profile of a particular client device;

FIG. 7 is a flowchart showing one embodiment of the Steps involved in the provisioning of a new lone worker monitoring profile in the monitoring database of the present invention;

FIG. 8 is one example of a representative screenshot of the user interface of the server of the present invention, demonstrating a client device log which could be generated based on stored client device data captured to the monitoring database;

FIG. 9 is one example of a representative screenshot of the user interface of the server of the present invention, demonstrating a map which was generated based on location coordinates captured in respect of a client device and stored in the monitoring database;

FIG. 10 is a flowchart showing one embodiment of the Steps involved in the administration of remote check-ins in accordance with the present invention;

FIG. 11 is a flowchart showing one embodiment of the monitoring and detection of immediate alert conditions in accordance with the present invention;

FIG. 12 is a flowchart showing one embodiment of the monitoring and transmission of periodic sensor data from the client devices to the monitoring server;

FIG. 13 is a flowchart showing a demonstrative embodiment of the Steps involved in receiving various data transmitted from client devices to the monitoring server and storing same in association with the associated lone worker monitoring profile in the monitoring database;

FIG. 14 is a flowchart showing the Steps in a demonstrative embodiment of the workflow software of the present invention in the detection and notification to the user interface of the server where a notification condition is detected in data received from a client device.

### DETAILED DESCRIPTION OF THE ILLUSTRATED EMBODIMENTS

As outlined above, the present invention is a method for the central monitoring and management of safety and location functions and check-ins for lone workers, which does not rely on purpose built hardware and uses otherwise publicly available communication networks for its implementation. The method is aided by the use of computer software in the rendering of necessary various calculations and method Steps. An employer or central safety provider would use the computer software the present invention to provide a centrally managed lone worker monitoring program for employers or other similar entities.

### Illustrative Environment and System Architecture:

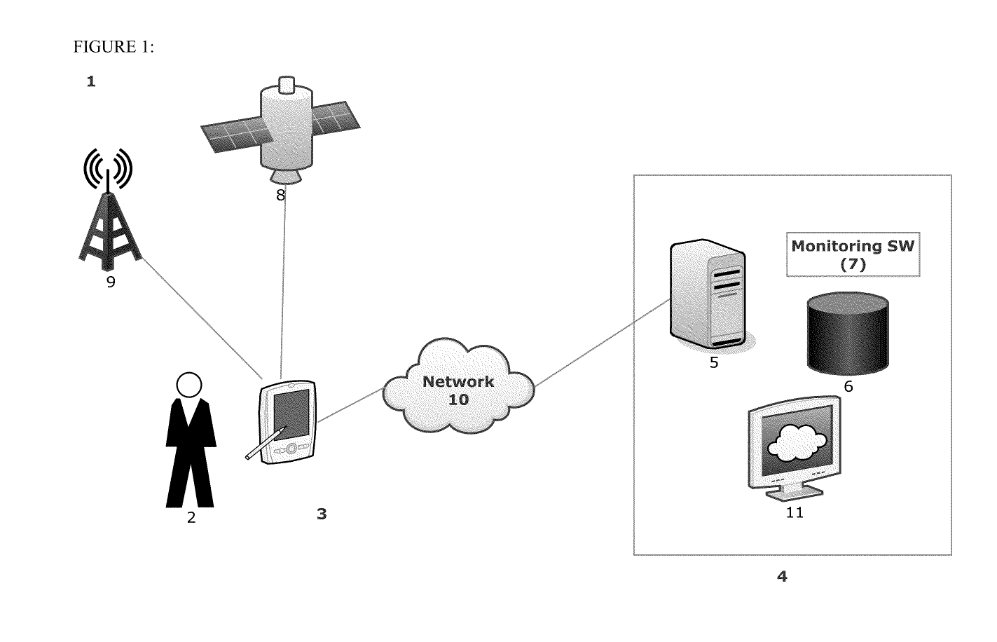

FIG. 1 shows an illustrative architecture 1 in which representative lone worker 2 employees use a mobile client device 3 to interact with a monitoring provider 4. The monitoring provider 4 would comprise or operate a monitoring server 5, and might include various software applications to manage interactions between the monitoring provider 4 and the client devices 3. The software applications on the monitoring server 5 would include monitoring software 7, responsible for the administration of the method of the present invention. The monitoring server 5 would also host a monitoring database 6, which is accessible to the software applications thereon, and would contain database records or information associated with a lone worker monitoring profile in respect of each pairing of a lone worker and a client device 3 which has been provisioned on the system.

Each client device 3 is location aware, or is able to provide information to another entity [e.g. monitoring server computer] to allow the other entity to determine the location of the device 3. A location on the surface of the earth, or a “geolocation” may be provided to the client device 3 by one or more satellites 8, such as a GPS satellite. Alternatively, wireless signals such as from a radio antenna 9 might be used to determine a geolocation of the client device 3 relative to a known position of the radio antenna 9. Other technologies and methods of determining the geolocation of a client device 3 are also envisioned within the scope of the disclosure such as, for example, calculating geolocation based on network access point or from a locator signal broadcast from a known location, such as at the monitoring provider 4.

The client device or devices 3 and the monitoring provider 4 may connect to a communications network 10. The network 10 may include any one or combination of multiple different types of networks, such as cable networks, local area networks, personal area networks, wide area networks, the Internet, wireless networks, ad hoc networks, mesh networks, and/or the like. In some implementations, the satellite 9 or the radio antenna 10 might provide network conductivity to the mobile client device 3 as well as providing geolocation.

The monitoring server 3 may house or otherwise have a connection to one or more data stores of various information required for operation of the method of the present invention. Specifically, the monitoring database 6 would be operatively connected and accessible thereto and within the monitoring database 6 are stored lone worker monitoring profiles 7 in respect of each client device 3 which it is desired to monitor in accordance with the method of the present invention. The lone worker monitoring profile 7 contains information about the lone worker 2 who is associated with the client device 3 associated with that lone worker monitoring profile 7. Additionally, as outlined in further detail below, the client devices 3 of related lone workers will stream various sensor data from accelerometers, gyroscopes, geolocation etc. back to the monitoring server 5 during operation of the monitoring method and the monitoring database 6 or database structures would be capable of capturing, storing and mounting for monitoring and interaction by the remainder of the monitoring server 5, the data within those sensor data streams.

One of the final elements of a typical embodiment of the infrastructure of the present invention would be a user interface 11 from which the monitoring provider 4 could interact with and operate the system of the present invention. One of the key elements of the method of the present invention is that the monitoring provider 4 will be responsible for provisioning lone worker monitoring profiles 7 within the database 6 and otherwise administering and operating the system and method of the present invention. The interface 11 might simply comprise a monitor and keyboard or the like, or other input output combination, operatively connected to the monitoring server 5 to locally administer and operate the monitoring software contained therein, or alternatively the interface 11 might also be another network computer or network client operatively connected to the network along with the monitoring server 5, which allowed an operator of the monitoring provider to locally or remotely administer and operate software on the monitoring server 5, for the purpose of provisioning lone workers and creating lone worker monitoring profiles 7, or to handle escalations or notifications where detected and received in accordance with the method of the present invention. Various types of operator interface embodiments are implementations will be understood by those skilled in the art of network and client/monitoring server design—for demonstrative purposes a monitor and keyboard interface is shown the Figure.

### Illustrative Client Device:

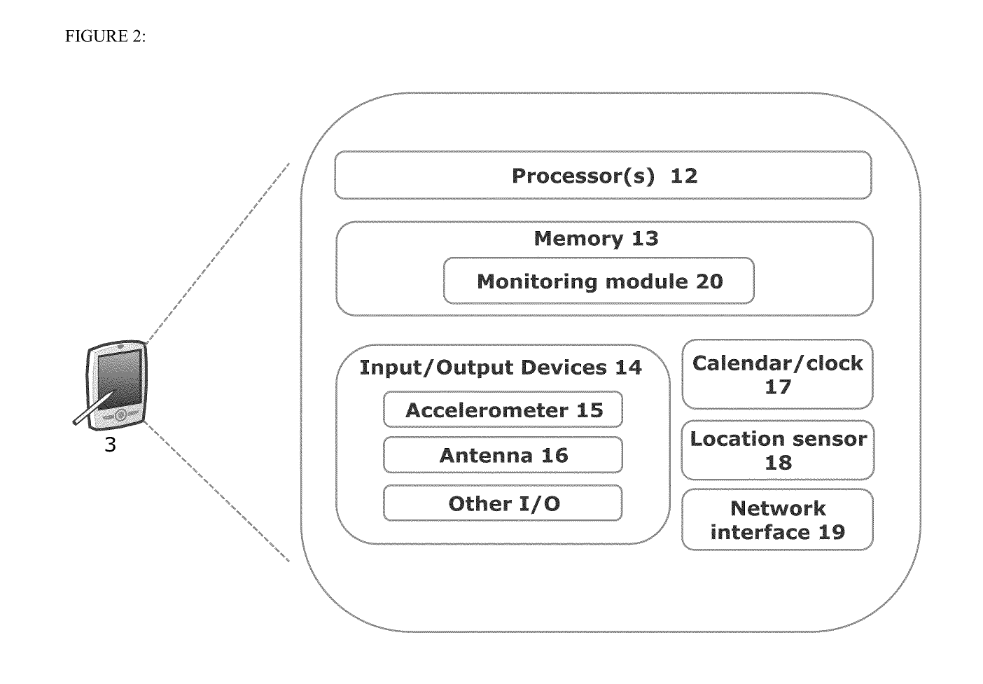

FIG. 2 is a schematic representation of the client device 3 of FIG. 1. The client device 3 includes one or more processors 12 and a memory 13. The memory 13 may include numerous software modules including a software module installed for the purpose of implementing the lone worker monitoring method of the present invention. Amongst the operating system or other software modules contained within the memory 13, there would be a lone worker device monitoring software 20 which contained the necessary software to, by interacting with the remainder of the software and hardware within the client device 3 provide the lone worker monitoring method of the present invention, including streaming periodic sensor data or immediate notification condition data back to the monitoring server.

The client device 3 also includes one or more input and output components 14 including touchscreen displays that might also function as an input device. An accelerometer 15 detects rotation or vibration of the client device 3. An antenna 16 in the client device 3 may send and receive wireless signals from sources such as the radio antenna 9 or the satellite 8. The client device 3 may also include additional input output devices 14 such as a microphone or a speaker for example, in an implementation in which the client device 3 functions as a telephone.

The client device 3 might also include a calendar/clock 17, location sensor 18, and a network interface 19. In some implementations as well, the calendar/clock 17 might communicate with the location sensor 18 to determine length of time at a particular location or the like. This could enable the client device 3 to determine whether or not movement has stopped for a particular period of time. The calendar/clock 17 and the location sensor 18 may also communicate to create a log of where the client device 3 is located at numerous time points. This log of time and place data may be transmitted to the monitoring server and logged in the monitoring database. The location sensor 18 includes any sort of system that informs the mobile device 3 of its geolocation including but not limited to the GPS system of satellites circling the Earth.

Alternatively the location sensor 18 may also determine geolocation by radio signal triangulation [i.e. triangulation based on radio antenna signal strength].

The network interface 19 may be configured for wirelessly communicating with the network 10. The network interface 19 may use any standard protocol for network communication. In some implementations, the network interface 19 might use the antenna 16 to send and receive data from the network 10. The network interface 19 might in certain circumstances also provide information to the hardware within the client device 3 including the location sensor 18 from which the location sensor 18 can calculate the geolocation of the client device 3.

Non-purpose built hardware, which uses pre-existing communication networks, would be used as the client devices 3 which would be carried and/or used by the lone workers for interaction with the system of the present invention. It is specifically contemplated that smart phones or tablets or the like, on the various public communications networks, would be the client devices 3 of choice for implementation of the present invention.

### Illustrative Monitoring Server:

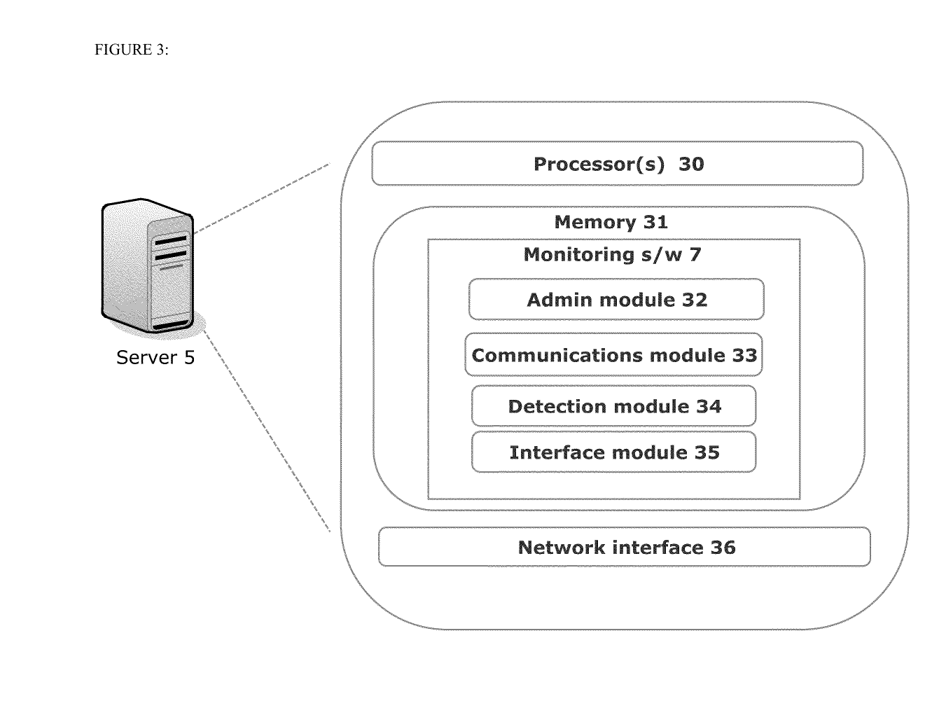

FIG. 3 is a schematic representation of one embodiment of a monitoring server 5 in accordance with the present invention. The monitoring server or monitoring servers 5 comprise one or more processors 30 and a memory 31. The memory 31 may contain various software components and processor instructions for use in the method of the present invention. The concept of a server 5 as a hardware component for use in a computer method such as that outlined herein will be understood to those skilled in the art and any type of a hardware component and associated software which can function in conjunction with the network, the client devices 3 and the monitoring database 6 in the execution of the remainder of the method of the present invention is contemplated within the scope hereof.

The monitoring server 5 would be operatively connected to the monitoring database 6. As can be seen in further detail in the Figure, there is also shown the monitoring software 7 which is one or more software components resident within the memory 31 of the server 5 which is used in the execution of the method of the present invention. The monitoring software 7, as shown in the embodiment demonstrated in this Figure, would include at least in the memory 31 an administration module 32 which would be responsible for the administration, entry and maintenance of information into the monitoring database 6 and specifically in the creation or administration of lone worker monitoring profiles within the database 6. The different modules shown in this Figure may actually in some iterations of the monitoring software 7 of the present invention comprise freestanding software modules, or in other cases may all be accomplished by a single software module—the individual modules demonstrated herein are shown for the purposes of demonstrating the various functions and functionality of the monitoring software 7 but any type of an actual architecture approach which results in the monitoring software 7 having the ability to execute the functions of the various software modules outlined in association with this Figure are contemplated within the scope of the present invention.

In addition to the administration module 32 there would also be a communications module 33. The function of the communications module 33 would be to administer and handle communications to and from client devices 3 in accordance with the remainder of the present invention. For example, client devices will transmit periodic remote check-in communications from the client devices to the monitoring server based on the remote check-in frequency designated in one or more of the lone worker monitoring profiles. The communications module could be responsible for receipt of those remote check-in communications from the client devices 3 via the remainder of the hardware and software of the server 5, and either individually or in conjunction with other functions and modules of the monitoring software 7, saving or storing those received remote check-in communications to or in association with the related lone worker monitoring profile in the monitoring database 6. Similarly, the lone worker device monitoring software installed in each client device might transmit periodic sensor stream data from the client device to the server from time to time, if the lone worker monitoring profile in question identifies one or more periodic sensor data streams which it is desired to capture for monitoring or storage in relation to a particular lone worker monitoring profile. The communications module 33 could receive any such communications received by the server 5 and again either individually or in conjunction with other functions and modules in the software 7 storing that captured periodic sensor stream data to the monitoring database 6 or in association with the monitoring database 6 associated with the corresponding lone worker monitoring profile. A final type of communication which could be received by the communications module 33 on behalf of the server 5 and the remainder of the monitoring software 7 would be any transmissions of the notification of existence of any immediate alert conditions at a quiet device. If a quiet device transmits a notification of the detection of existence of any immediate alert condition defined in the associated lone worker monitoring profile to the monitoring server 5, the communications module 33 could receive those transmissions and again store them in association with the related lone worker monitoring profile. As outlined elsewhere herein, every transmission from a client device to the monitoring server would include the location coordinates of the client device and these would also potentially be stored to the monitoring database 6—the location coordinates could be parsed or extracted from every transmission from the client device for storage to the database in relation to the corresponding lone worker monitoring profile.

There is also shown a detection module 34. The detection module 34 or function would come in conjunction with the other software and hardware components of the monitoring server 5 monitor the various data received from client devices including remote check-in communications, periodic sensor stream data and immediate alert condition notifications received from client devices and saved in relation to the related lone worker monitoring profiles in the monitoring database 6. The detection module 34 would be responsible for the scanning or monitoring of the contents of the monitoring database 6 and any stored client device data to identify specifically the failure of a particular client device to transmit to the server 5 a remote check-in communication on a timely basis based on the remote check-in frequency assigned to the lone worker monitoring profile, identifying any periodic sensor stream data received from a client device that was outside of the acceptable parameters for periodic sensor stream data which might be saved within the lone worker monitoring profile and as a result of which notification was desired, or to detect the existence of any immediate alert condition at a client device based on the receipt of a notification of the existence of an immediate alert condition from the client device which has been stored to or in association with the monitoring database 6 and the associated lone worker monitoring profile. Notification of the detection of any such condition, namely failure to timely check in, periodic sensor stream data exceeding acceptable parameters in that was defined in the lone worker monitoring profile, or the existence of any immediate alert conditions at a client device, would be made by display or other indication to an operator of a monitoring console or user interface attached to the server.

Another software module which would be resident within the memory 31 of the monitoring server 5 would be an interface module 35. The interface module 35 would comprise the necessary software to drive input and output hardware associated with the remainder of the server 5, to allow for user interaction with the monitoring server 5 in the provisioning of lone worker monitoring profiles in the monitoring database 6, in conjunction with the administration module 32, by a user on the monitoring server and the interface thereof. The interface module 34 could also provide any specific additional required user interface or interaction vis-à-vis periodic or safety-based notifications with respect to users being monitored by the system of the present invention, as well as providing any kind of a reporting interface for the purpose of querying or reporting the contents of the monitoring database 6 with respect to a particular lone worker or a client device or pairing thereof, since it is specifically contemplated that in delivering this type of an enterprise lone worker monitoring system one of the benefits of this system and method with the capture of streams of sensor or other location or safety data and respective lone worker client devices 3 to the database 6 will be to allow for detailed and advanced reporting to be generated with respect to physical movement or location of a client device 3 over time, or other safety parameters related to a particular lone worker, based on the data which is captured. The concept of an interface module 35 is a reasonably broad one—the interface module 34 per se will be understood by those skilled in the art to be any necessary software, firmware or the like to be installed on the server 5 in conjunction with the remainder of the software or processor instructions therein that can drive the user interface, as well as specifically interface between the monitoring database 6 and the remainder of the components and software resident on the server 5 to provide user notifications of the detection of any alert or notification conditions as outlined above, as well as to provide access to any integrated reporting interface or requirements.

Also shown in the Figure is a network interface 36—the network interface 36 again as will be understood by those skilled in the art could be any wired or wireless interface using a network protocol which allowed the monitoring server 5 to communicate with client devices 3 over a wide or local area network. The concept of the incorporation of a network interface 36 in a server 5 will be understood to those skilled in the art and all network designs, architectures and protocols as will be understood to those skilled in the art or contemplated within the scope hereof.

### Monitoring Database:

Another key component resident upon or accessible to the monitoring server 5 is a monitoring database 6. The monitoring database 6 contains lone worker monitoring profiles with respect to different pairs of lone workers and their client devices 3 which it is desired to monitor in accordance with the remainder of the system and method of the present invention.

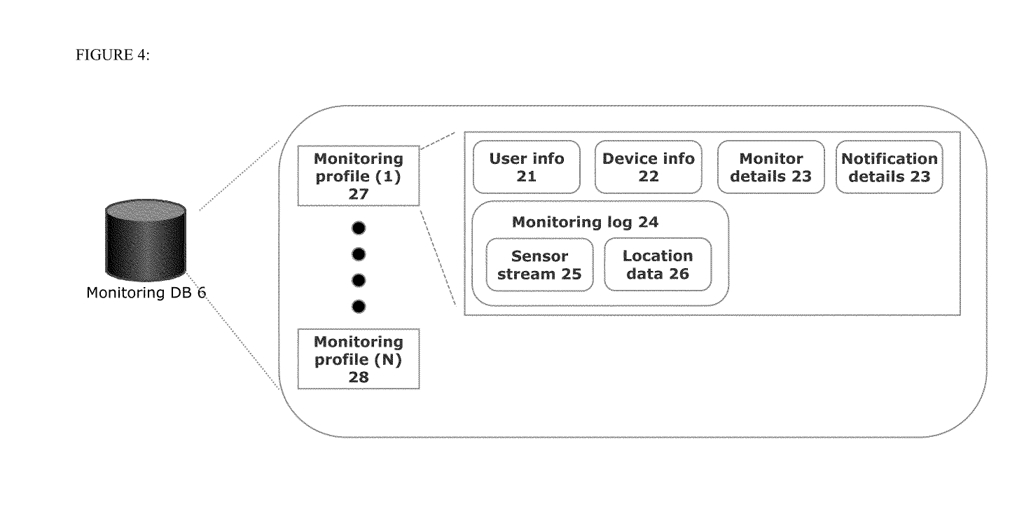

FIG. 4 shows one illustrative embodiment of the contents or structure of a monitoring database 6 in accordance with the present invention. The monitoring database 6 includes information pertaining to lone workers monitored by the method of the present invention along with their client devices 3. Identifying information with respect to particular workers and their client devices 3 would be stored in lone worker monitoring profiles 27—there would be a lone worker monitoring profiles 27 stored within the monitoring database 6 in respect of each lone worker and client device pair. For demonstrative purposes, a plurality of lone worker monitoring profiles 27 within monitoring database 6 are shown in the Figure—from the first lone worker monitoring profile 27 in respect of the first pairing of a lone worker and their related client device through to the Nth lone worker monitoring profile for the additional pairs of lone workers and client devices monitored therein, with the final of the plurality of lone worker monitoring profiles shown for demonstrative purposes at 28.

The lone worker monitoring profile 27 in respect to each discrete pairing of a lone worker and client device 3 would include additional and various necessary information for the system and software of the present invention to conduct the monitoring and notification system outlined herein. There is shown for example, user information 21, which could include name or other identifying information which would be used for escalation, notification or reporting purposes by the system of the present invention, in respect of the lone worker to the lone worker monitoring profile 27 corresponds. In addition to the user information 21, there would also be device information 22 related to the client device 3 of the lone worker. The device information 22 might for example include network address information such as the MAC address or the like for the client device 3, so that information received from and transmitted to the device 3 via the network during operation of the method of the present invention could be properly identified and stored to the monitoring database 6. Various network addressing systems could be used, either including the MAC address, an email or device communications address, phone number or the like. Any tin addition to network address coordinates for the client device 3 related to the lone worker monitoring profile 27, device information 22 might also include the phone number for example of the client device 3 where the client device was a telephone. Additional types of network addressing protocols that allow for the discrete or serial addressing of client devices 3 will be understood to those skilled in the art. Other technical information in respect of the client device 3 of a particular worker could also be stored in the device information 22 of the lone worker monitoring profile corresponding thereto.

A desired remote check-in frequency could also be stored as monitoring details 23 in a lone worker monitoring profile 27 with respect to each pair of a lone worker and client device. Additional parameters which were required for the monitoring of additional safety conditions, as outlined elsewhere herein, would also be stored as monitoring details 23—for example parameters around timeframe within which ceased movement of the device 3 associated with a particular lone worker monitoring profile would trigger an alert, accelerometer feedback readings or ranges or the like could all be monitor details 23 stored in respect of a particular client device and related lone worker.

Following the storage of monitoring details 23 which would prescribe the framework within which lone worker feedback was required from the worker and the device associated with that profile or the parameters or ranges of acceptable operation with respect to other safety conditions which would be monitored, it may also be desired to store certain details with respect to the type of escalation or alert which should be generated if a failure of check-in or safety condition breach was detected with respect to a particular lone worker monitoring profile 27 within the database 6—for example the coordinates to whom alert should be dispatched etc. by the central monitoring server. These could be stored as notification details 23 within a separate data set within the database 6 with respect to each lone worker monitoring profile, or could be stored elsewhere within the lone worker monitoring profile of the database 6. It may also be the case that notification details 23 such as this were not specifically required if the same type of notification or escalation of any type of a condition breach was to be applied regardless of the lone worker or the profile.

Finally in addition to the various lone worker and device information which would be stored with respect to a lone worker monitoring profile 27 within the database 6, either within the monitoring database 6 or within another related table or data structure, sensor and location data which was transmitted from the client devices 3 to the monitoring server 5 would be stored within the database or accessible to the database for monitoring, historical or reporting purposes. This is referred to elsewhere herein as stored client device data. Shown in the illustrative example of a monitoring database 6 demonstrated in this Figure is a monitoring log 24 which includes two sets of data, the first of which being the sensor stream data 25 which is captured from the client device 3 and recorded or saved to the database 6—for example accelerometer data, details of timing or other feedback on remote check-ins which are conducted by the lone worker from the device, or other similar types of information. In addition to contemporaneous or periodic sensor stream transmissions from the client device or devices 3, it is also understood that in certain types of monitoring scenarios the detection of an immediately notifiable condition at the client device 3 by the software thereon, which resulted in immediate transmission of a notification to the monitoring server from device, could also be logged to the monitoring log 24. It is likely that any type of sensor or other data transmitted from the device to the monitoring server for recordal to the monitoring database 6 would be geo-referenced as well so that both the time and/or the location of the device at the time that the particular reading or data was generated or captured could be transmitted to the database and time stamped or location stamped onto the records created within the database 6 along with the underlying data itself—this would again allow for monitoring server-side processing or monitoring of more conditions as well as for historical reporting and logging to take place. A location data set 26 is also shown in this Figure—beyond geo-referencing of other sensor readings and the like it may be desirable to simply capture the location of the device or devices 3 from time to time so that mapping or reporting could be done on this if required from a safety or other enforcement or monitoring perspective at some point in the future.

It would also be possible in this type of an implementation, since the location is periodically transmitted and captured to the monitoring database 6, to either at the monitoring server end of the monitoring loop or by transmission of notification back to the client device 3, to implement geo-fencing or awareness whereby if the location of the client device 3 was detected to have departed from an approved operating area, alert or notification could be triggered.

The various types of data structures which could be used in a monitoring database in accordance with the software and method of the present invention will be understood to those skilled in the art. Any type of a data structure which was capable of storing the lone worker monitoring profiles associated with the client devices of lone workers managed and monitored pursuant to the system, as well as capturing and storing the periodic sensor data stream of the client devices of lone workers and/or data received in terms of the notification by client devices via the network and the method to the monitoring server of immediate notification conditions will be within the scope of the present invention.

### Lone Worker Device Monitoring Software:

The lone worker device monitoring software 20, which is the software component installed upon the client devices 3 would have the purpose of effectively, using the hardware and software components of the client device 3, being able to access and interact with the lone worker monitoring profile 27 associated with the client device 3 in the database 6 via the network interfacing communication server with the monitoring server 5, which would allow the device monitoring server 20 to access as required parameters for operation of the method of the present invention on the particular client device 3 and the like. The lone worker device monitoring software 20 would also, by interaction with the input and output components of the client device 3, allow a lone worker to manually or automatically trigger the transmission of a remote check-in communication from the client device 3 to the monitoring server 5, based upon the remote check-in frequency or other details in the lone worker monitoring profile stored on the server 5.

In addition to the ability to generate and transmit a remote check-in communication to the server 5, including possibly presenting to the lone worker using the client device 3 a device display by which they can provide a physical check-in response and transmit that back to the monitoring server 5 in certain embodiments, the lone worker device monitoring software 20 would also fulfill a couple of other key Steps in the method of the present invention. Firstly, since the client device 3 is locationally aware, lone worker device monitoring software 20 would query the location sensor 18 and attach the location coordinates of the client device 3 along with the remainder of any data packets transmitted back to the server 5, so that any responses dispatched from the client device 3 to the monitoring server 5 are geo-referenced.

There are also two types of additional condition monitoring which are a key part of the method of the lone worker monitoring system of the present invention and in respect of which there is some requirement of functionality in the lone worker device monitoring software 20. Firstly, the lone worker device monitoring software 20 would be capable of capturing, extracting or querying from time to time a periodic stream of sensor data from relevant sensors or input/output hardware resident within the client device 3, and transmitting those as a periodic sensor data stream to the monitoring service 5 for comparison with periodic sensor stream data parameters stored in the lone worker monitoring profile 27 related to that particular client device 3 and lone worker. Periodic sampling of the sensor data available on the hardware of the device 3 to yield a metric or measurement of whether or not movement of the device has ceased for example, either by comparison of adjacent pairings of location and timestamp coordinates, or by comparing adjacent accelerometer readings etcetera to sense a cessation of movement by the client device is one example of a sensor data monitoring approach which could be undertaken in accordance with the remainder of the method of the present invention.

The lone worker device monitoring software 20 can also monitor and/or detect the existence of any immediate alert conditions at the client device 3, and if an immediate alert condition does exist, transmit the existence of that condition to the monitoring server 5 from the device 3 for notification or escalation in accordance with the remainder of the present invention. Immediate alert conditions, as will be understood from the remainder of this application, are the types of conditions which can be detected on a safety basis most likely—i.e. the existence of a particular type of an immediate alert condition is probably an indicate of the existence of a safety problem in respect of which an immediate monitoring notification would be desirable. For example the detection of a fall or abrupt movement would comprise an immediate alert condition which might be notified to the monitoring server for escalation and notification. There are other types of immediate alert conditions which can also be incorporated into the method of the present invention in addition to endeavoring to detect abrupt falls or movements of the client device 3. It may even be possible within the interface software or administrative component aspects of the monitoring software seven on the server 5, in which the low marker monitoring profiles 27 are created, to allow for a customizable or logic-based interface by which the user of the server could create customized immediate alert condition detection scenarios such that any type of a customized sensor pattern could comprise a “immediate alert condition” which would be notified to the monitoring server, or detected by the monitoring service monitoring the received periodic sensor stream data.

In the case that the client device 3 is a smartphone or the like, the lone worker device monitoring software 20 created for use thereon in accordance with the method of the present invention would be a software app which could be installed. The specific nature of the coding for the software to be created, so long as it accomplishes the objectives outlined herein on a lone worker monitoring device software 20 which can be installed on the client device 3 in accordance with the remainder of the present invention to accomplish the various necessary client-side Steps which are required to, overall, accomplish the monitoring method of the present invention, is all contemplated within the scope of the present invention and various programming languages or programming approaches will all be understood to those skilled in the art of mobile computing software application design without departing from the intention and scope hereof.

### User Interface of the Server:

As outlined elsewhere above, the software which will be resident and required on the monitoring server 5 comprises numerous modules although these three modules might be combined or programmed in various different ways again without departing from the scope of the present invention. There will be an administration module 32 which is responsible for the creation of lone worker monitoring profiles within the monitoring database 6, a communications module 33, a detection module 34 which would actually be the monitoring engine, so to speak, which would monitor the data which is captured from various provisioned client devices 3 having lone worker monitoring profiles within the database 6, and the user interface or interface module functionality 35 which effectively is considered to be the user input output interface for the administrative and detection modules as well as any other type of mapping or reporting etc.

These software instructions would need to be resident within the memory 31 of the monitoring server 5, either separately or in combination, and would need to have access through the remainder of the software and hardware combination of the monitoring server 5 to the network interface 36 for transmission and receipt of communications between the monitoring server 5 and client devices 3, as well as connection to the monitoring database 6 into which lone worker monitoring profiles can be created, stored in adjusted and various data transmitted from client devices 3 can be saved in conjunction with their associated lone worker monitoring profiles for monitoring by the detection module 34.

### Method Overview:

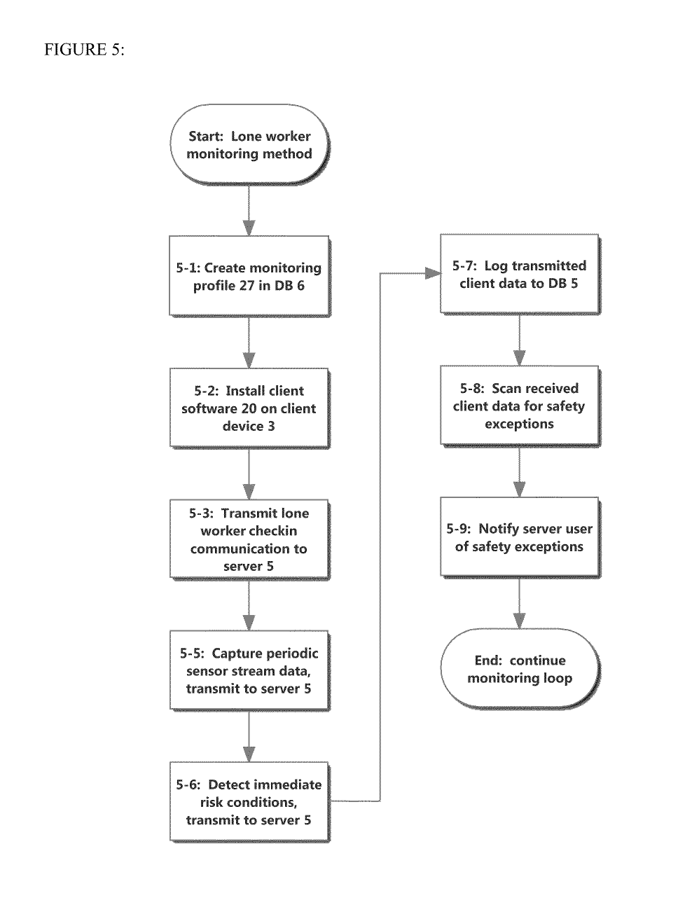

FIG. 5 is a flow chart demonstrating one embodiment of the overall method of the present invention. The first Step, shown at 5-1, is to provide a monitoring database which is operatively connected to the monitoring server which contains a lone worker monitoring profile 27 corresponding to each lone worker to be monitored and their corresponding client device 3. The lone worker monitoring profile 27 for each pairing of a lone worker and their client device contains the parameters required for the safety monitoring method of the present invention includes at least the following parameters with respect to each lone worker and their corresponding client device 3. Firstly it includes a designated remote check in frequency for the associated client device. Remote check-in frequency as outlined elsewhere herein could vary from client device to client device and lone worker monitoring profile to lone worker monitoring profile, or could be fixed at the same frequency for all users and clients within the system. As well, the check in frequency for a particular lone worker monitoring profile could be periodically randomized.

The second parameter which would be contained within each lone worker monitoring profile 27 would be the parameters of any periodic sensor stream data which was to be captured and stored in respect of the client device 3. Part of the method is to monitor the periodic sensor stream data captured to detect any departure from those parameters stored within the lone worker monitoring profile 27, such that if any departure from the acceptable parameters is detected a notification to the operator the monitoring server will be initiated. Additionally, the parameters of any immediate alert conditions which can be sensed by the associated client device upon the detection of which a notification should immediately be triggered to the operator of the monitoring server would be also indicated within the lone worker monitoring profile 27. Creation of lone worker monitoring profiles 27 within the monitoring database 6 is shown at Step 5-1.

While the method and flow chart of FIG. 5 applies to the creation and monitoring of a single lone worker monitoring profile 27 for a single pairing of a lone worker client device it will be understood that this is purely demonstrative and that would be in most if not all circumstances be a large plurality of lone worker monitoring profiles 27 that would be tracked in a single implementation of the method.

The next Step which is shown at Step 5-2 is the installation of the lone worker device monitoring software 20 software on the client device 3. The lone worker device monitoring software 20 is the client software which will be installed on the client device 3 of the lone worker and which will communicate via the network interface of the client device 3 with the monitoring server 5 and the software components thereon in execution of the monitoring method of the present invention. Once the client software 20 is installed on the client device 3 and a corresponding lone worker monitoring profile 27 has been created in the monitoring database 6 the monitoring method itself of the present invention can be initiated with respect to the client device 3 and its user/lone worker.

The lone worker device monitoring software 20 on the client device 3 will monitor the predetermined remote check-in frequency with respect to the lone worker monitoring profile of the client device 3 and upon arrival of the appropriate time will transmit a remote check-in communication to the server 5. This is shown at Step 5-3. The lone worker device monitoring software 20 on the client device 3 will generate this transmitted remote check-in by presenting to the user of the client device 3 an interface or request for a physical human interaction with the device which will comprise a remote check-in communication which can be transmitted back to the monitoring server for logging in respect of the corresponding remote check-in prompt. The remote check-in communication when transmitted will identify the client device 3 or otherwise provide sufficient identifying matter to allow for the storage of the remote check-in communication in respect of the corresponding lone worker monitoring profile 27 in the database 6.

In addition to monitoring remote check-in communications received, the monitoring server 5 will also receive transmissions of periodic sensor stream data from the client device 3 and its lone worker device monitoring software 20. Various types of periodic sensor stream data might be transmitted including location coordinates or other sensor stream or sensor hardware readings which it is desired to capture for logging or safety monitoring purposes. The transmission of captured periodic sensor stream data is shown at Step 5-5.

The third stream of safety monitoring which is included within the method of the present invention, in addition to the tracking of remote check-in communications and periodic sensor stream readings is the detection of immediate alert conditions. Shown at Step 5-6, the lone worker device monitoring software 20 will monitor the sensors or other hardware or software aspects resident upon the client device 3 to detect any immediate alert conditions such as a fall or abrupt movement of the device, stopped movement etc., and will transmit the detection of any such immediate alert conditions to the monitoring server 5.

At the monitoring server 5, the software 7 thereon will receive, parse and store all of the received client device data to the database 6 in conjunction with the corresponding lone worker monitoring profiles 27. There will then be a monitoring engine or routine within the software 7 resident upon the monitoring server 5 in accordance with the remainder of the present invention which will scan any received client device data to identify safety exceptions including the cessation of movement of a client device, a fall or abrupt movement, a failure to timely provide a remote check-in response, or any other exceptions in terms of periodic sensor stream data readings or detected immediate alert conditions. Should any such exceptions or safety notification conditions be detected or determined to exist, the next Step in the method, shown at Step 5-9 is to notify the user of the monitoring server 5 via a user interface of the server 5. The monitoring of received client data transmissions will continue in a monitoring loop during the appropriate working time.

### Provisioning Lone Workers and Client Devices:

In order to commence the monitoring of a particular lone worker user in accordance with the system and method of the present invention there are two high-level Steps which need to be undertaken. Lone worker device monitoring software 20 needs to be installed on the client device 3 of the worker, and a lone worker monitoring profile 27 needs to be created for that worker and their paired client device 3 within the monitoring database 6.

The monitoring database 6 will be only administered by the user of the user interface of the server 5. A lone worker themselves will not be able to, directly or indirectly through some type of browser or other client/monitoring server interface from the client device 3, provision a lone worker monitoring profile 27 in the database 6 or otherwise enable the system for operation. There are a couple of reasons for this—the first of which is that it is desired to maintain stricter control over the configuration and settings than might be possible where each lone worker is getting to make their own adjustments. From an enterprise level this will be preferable. It will result in a more rigid structure but it should also result in higher quality data being captured, both for compliance as well as historical and reporting purposes. Allowing for a single point of entry in terms of the provisioning of new lone workers and client devices will also minimize the bandwidth and size required for the lone worker device monitoring software 20 to be installed on a client device 3 in accordance with the present invention which will also be desirable.

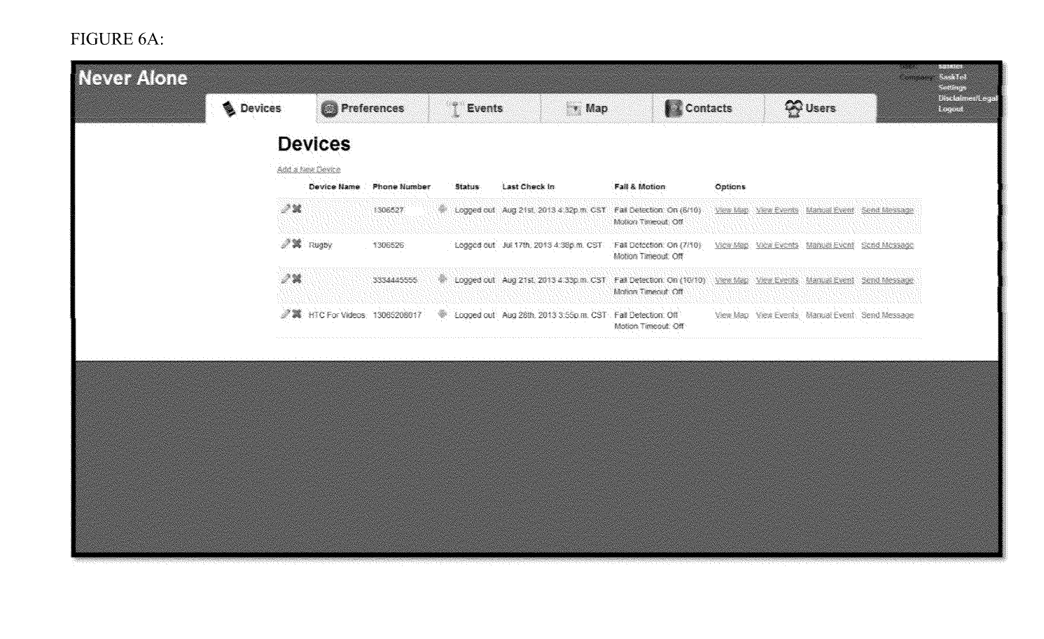

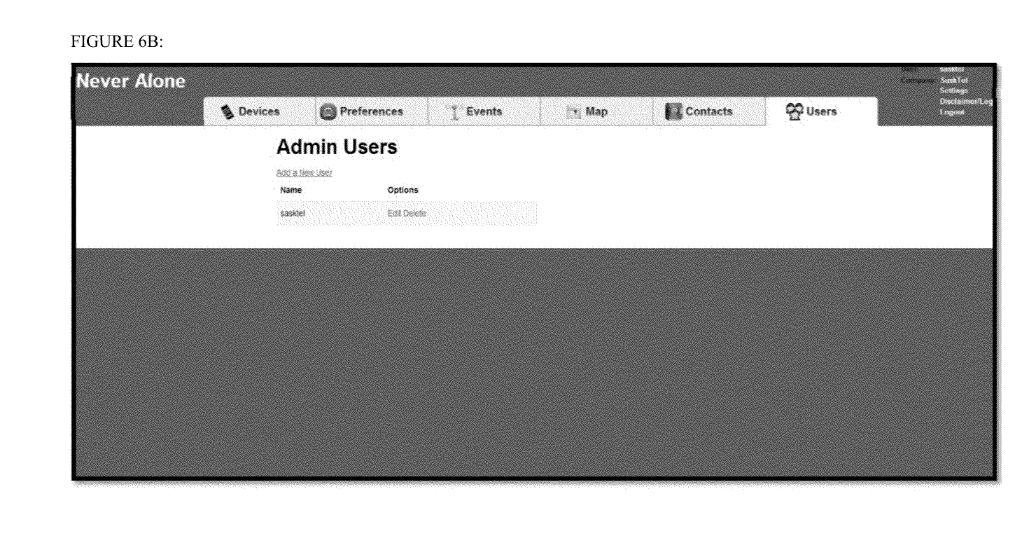

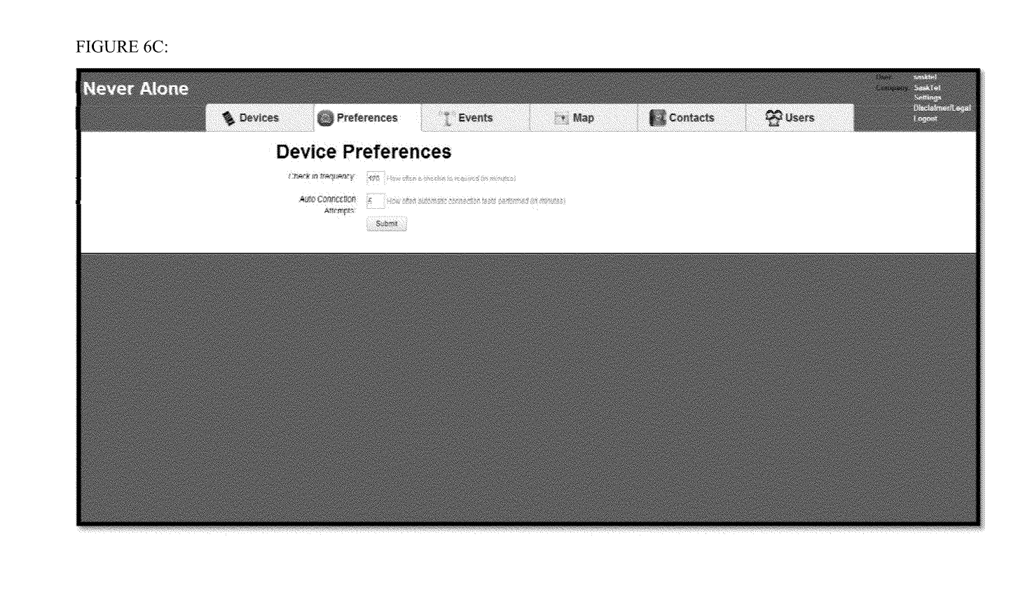

The operator of the user interface of the server 5, to provision the system to monitor the safety and check-in of the new lone worker, will enter into the administrative module of the interface software which permits the creation, adjustment or deletion of lone worker monitoring profiles 27 from and to the monitoring database 6. FIG. 6 is a representative screenshot of a user interface of the server 5, which demonstrates one type of a screen which could be created in a database interface to allow for the pairing of lone workers and client devices 3 through the creation of lone worker monitoring profiles 27 in the monitoring database. It will be understood by those skilled in the art of database and client/monitoring server programming that many different types of friends or interfaces could be created for use in the user interface of the server which would achieve the same objective and all such modifications are contemplated within the scope of the present invention.

FIGS. 6A through 6C are included to provide a demonstrative outline of the type of a user interface of the server which could be created for use in accordance with the remainder of the present invention at the monitoring server, to provision or administer the lone worker monitoring profiles 27 associated with various lone workers and their client devices 3. These particular screenshots are provided based on one embodiment of the user interface of the server and user interface of the monitoring server of the present invention but it will be understood by those skilled in the art that many different types of user interfaces could be created which would accomplish the same objective and are as such contemplated within the scope of the present invention. As well, the user interface design might be dependent to a degree upon the level of complexity in the underlying structure of the monitoring database 6—in certain embodiments of the method of the present invention where additional parameters were stored within lone worker monitoring profiles within the monitoring database will be understood that the user interface in the circumstances might require additional complexity—versus the fairly simple prototypical embodiment demonstrated herein, both of which are contemplated again as outlined within the scope hereof.

FIG. 6A is a prototypical interface screen listing the client devices or lone worker monitoring profiles resident within the monitoring database 6 in a particular embodiment of the present invention. This type of a screen or interface would be used in many if not all present-day embodiments of a database interface—providing the user of the user interface of the monitoring server with an interactive list through which they can drill down to the details of lone worker monitoring profiles in association with particular client devices and administer, change or review same.

FIG. 6B is one sample embodiment of a screenshot in a user interface listing the details of users also known as lone workers in accordance with the present system. As outlined throughout, the concept of pairing a lone worker with the client device would result in the need for lone worker information as well as client device identifying information to be stored in conjunction with a particular pairing of a client device in a lone worker for monitoring purposes in accordance with the remainder of the system and method of the present invention. Again it will be understood that many different types of interfaces could be provided which would accomplish the same objective of allowing in the configuration or provisioning aspect of the user interface of the monitoring server for the user thereof to enter information pertaining to particular lone workers to be monitored in accordance with the remainder of the system or method and all such approaches are contemplated within the scope hereof.

FIG. 6C is a sample screenshot of a prototypical interface screen in accordance with certain embodiments of the method of the present invention—specifically this is a sample screenshot of a user interface through which a user thereof could configure the remote monitoring settings in relation to a particular client device. It can be seen in this screenshot that a particular monitoring frequency or interval in respect of the device can be sent, and as outlined elsewhere herein this interface could also include the ability to enter additional parameters for monitoring as well. Again, all such modifications in terms of the programming of a client interface on the user interface of the server which would allow for the administration and creation of lone worker monitoring profiles in the monitoring database in accordance with the remainder of the present invention are contemplated within the scope hereof.

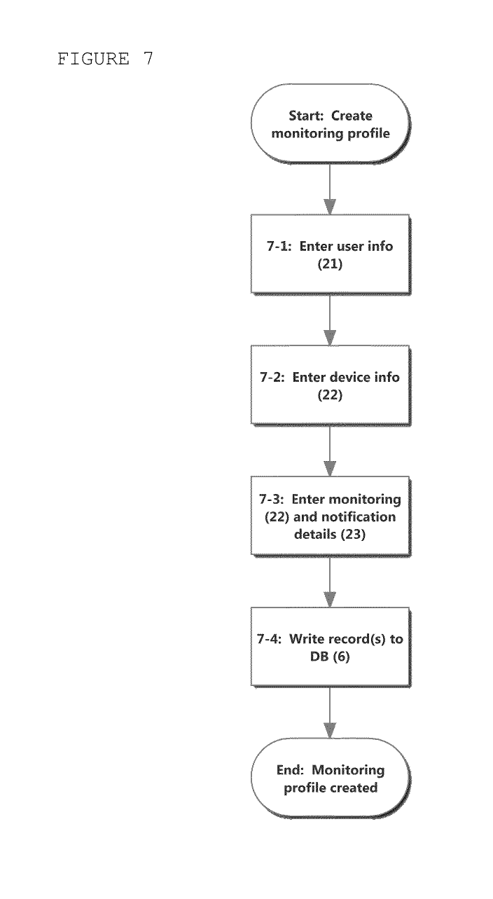

FIG. 7 is a flow chart demonstrating one embodiment of a process for the provisioning of a lone worker on the system and more particularly the creation of a lone worker monitoring profile 27 within the database 6 with relation to the lone worker. Effectively identifying lone worker information is paired or associated with details of the client device 3 carried by the lone worker. The user information 21 might comprise for example name, address or other information which is useful from a reporting perspective—associating user information 21 with the device information 22 ties the identity of the lone worker to the client device and allows the client device 3 to represent the lone worker in electronic transactions with the system of the present invention.

Shown at Step 7-1 is the entry of user information 21. Following the entry of user information, as outlined above, the corresponding client device 3 information, shown at Step 7-2, would be made. Additional monitoring and notification details 22, 23 would be entered in another Step 7-3. These details would include for example specifying the frequency within which remote check-ins are required, parameters around fall detection or the timing within which movement needs to be detected before an immediate alert condition is detected and alerted based on a cessation of movement, or any other type of monitoring or notification details. These monitoring and detection parameters etc. are all saved with the remainder of the lone worker monitoring profile 27 when it is written to the monitoring database 6, shown at Step 7-4. Once a lone worker monitoring profile 27 such as this, which includes the address information of the client device 3, such as the network address, MAC address etc. of the client device 3 is completed and the lone worker device monitoring software 20 is installed on the client device 3 itself such that it can send and receive communications with the monitoring server 5 and its related monitoring server and software components, it is possible to start monitoring the lone worker and their related client device 3 in accordance with the invention.

Various technical approaches to the provision of the user interface and the necessary related software components to create and administer the lone worker monitoring profiles 27 and related parameters within the monitoring database 6 will be understood by those skilled in the art and all such approaches are contemplated within the scope of the present invention.

### Multiple Data and Detection Streams:

One of the key differentiators in the system and method of the present invention from others in the prior art is that the present invention specifically anticipates handling the monitoring of additional periodic or immediate safety or risk conditions in addition to remote check-ins. This will provide in an enterprise implementation an added layer of worker safety as well as a better reporting ability for cases where it was desired to maintain historical logs of work environment parameters etc. for various reporting purposes—for example the ability to map the route of lone workers historically or even as they are working, tracking periods of inactivity or other safety monitoring events in addition to the timely provision of remote check-in requests will provide a better historical and audit ability.

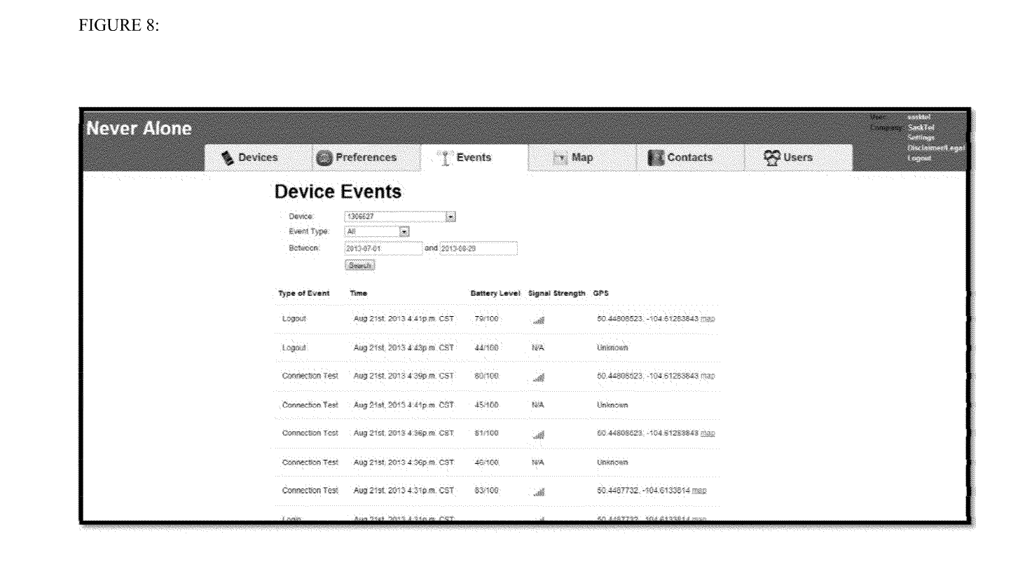

As outlined elsewhere herein various types of logging, auditing or reporting could be configured in conjunction with the remainder of the system of the present invention. The various data captured to the monitoring database 6 could be used either on a periodic reporting basis or even on the basis that the user of the user interface of the monitoring server could query the database in respect of a particular client device 3 for information. FIG. 8 is a sample screenshot of one embodiment of a monitoring log which could be created based upon location and status check-ins and feedback from client devices 3 to the database 6.

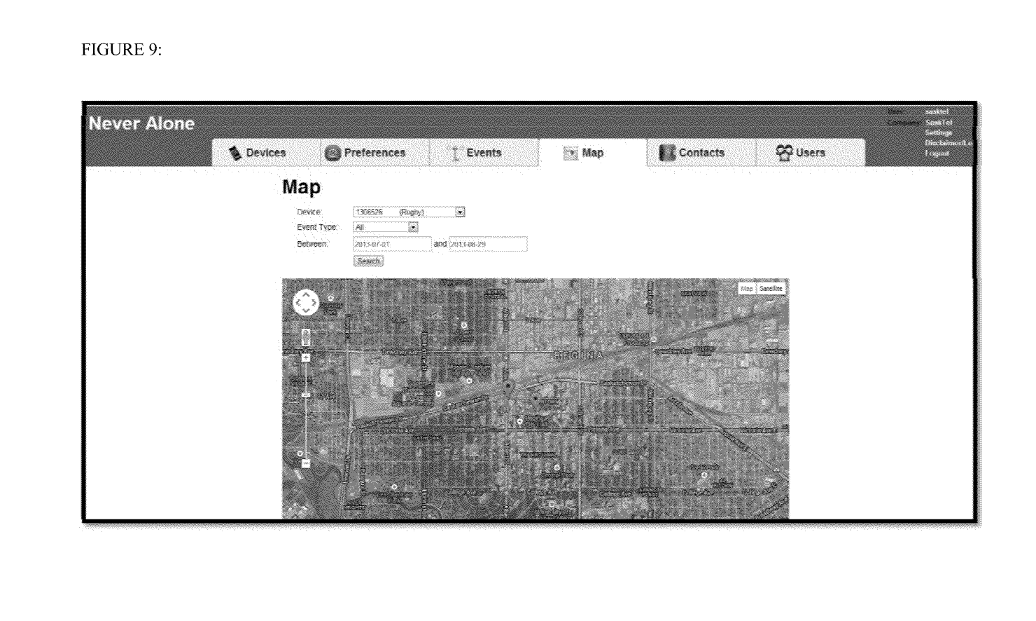

Given that the client devices 3 are locationally aware and it is specifically contemplated that the client devices 3 will transmit their geo-referenced location coordinates to the monitoring server for storage in the monitoring database in conjunction with the associated lone worker monitoring profile 27 in all transmission circumstances. One of the other added benefits of the system of the present invention which is specifically contemplated is the ability to provide a real-time map interface which would show the location of various client devices 3 within the system, or which can also provide historical mapping with relation to one or more specific client devices 3. FIG. 9 is a demonstrative screen capture of one illustrative embodiment of a map-based client interface, demonstrating the current location of a plurality of client devices 3 in respect of a geographic map. It will be understood that various types of mapping tools and mapping reports and approaches could be implemented in accordance with or as an extension of the underlying method of the present invention and all such approaches are contemplated again within the scope hereof.

### Remote Check-in Communication:

Three specific types of data and detection streams are contemplated with respect to the method of the present invention and are outlined in further detail herein. The first data or detection stream which is contemplated is a remote check-in data stream—namely the provision of remote check-in communications from the client devices 3 of lone workers via the network to the server 5 for storage in association with the lone worker monitoring profiles 27 associated therewith. The lone worker monitoring profile 27 will include a desired remote check-in frequency. If a remote check-in communication is timely received, the server 5 and related software will simply log the details of that into the monitoring database 6 with respect to the related lone worker monitoring profile 27 and continue monitoring, and alternatively if a lone worker fails to timely provide a remote check-in communication, either the software 20 on the client device 3 or the software 7 on the server 5 can provide escalation and notification both to the lone worker at the client device 3 as well as to the user interface of the server 5 and the monitoring center.

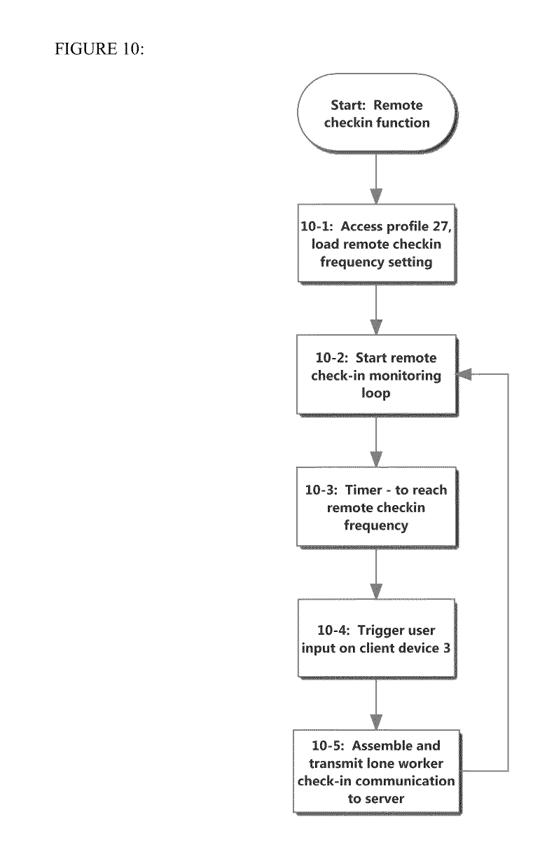

FIG. 10 is a flow chart demonstrating the steps of one embodiment of a remote check-in work flow of the present invention in respect of remote check-ins and that first data stream outlined. This Figure shows the steps that are involved in triggering a remote check-in from the client device 3. As outlined above, the apparatus required would be a client device 3 paired with a lone worker by way of a lone worker monitoring profile 27, in accordance with the remainder of the system of the present invention.

The first step in the remote check-in function which is showed at step 10-1 is that the client device software 20 on the client device 3 would access the lone worker monitoring profile 27 in respect of the particular client device 3 and lone worker pairing, and load or verify the remote check-in frequency setting which is stored therein. As outlined in further detail elsewhere in this document, the remote check-in frequency might be the same for every user and device pairing on the system, or could be varied or even randomized—as the start of the remote check-in function, the software 20 on the device 3 would need to load the remote check-in frequency setting.

The next step in the method is a remote check-in monitoring loop, which is shown starting at step 10-2. The lone worker client device software 20 on the client device 3 would, upon commencement of this check-in monitoring loop 10-2, run a timer or otherwise time the lapse of time from the commencement of the monitoring loop to the arrival of a remote check-in frequency or check-in time. This is shown at step 10-3. At the arrival of the time in which a remote check-in is to be made by the lone worker on their client device 3, the software 20 on the client device 3 would trigger a user input of some kind on the client device 3, shown at step 10-4, to initiate the preparation of a transmission back to the server. The triggering of a user input on the client device 3, shown at step 10-4, could be anything from simply presenting a press button on the interface of the client device 3, providing some kind of an auditory or visual alert and requiring the entry of a password or any other type of an interface which was desired to simply require the user to indicate to the system their well-being and their status, which could be transmitted. Following the triggering of a user input, shown at step 10-4, presuming that the user input is completed, the next step in this workflow, shown at step 10-5 would be for the lone worker client device software 20 to assemble and transmit a remote check-in communication to the server 5. The remote check-in communication which is transmitted to the server 5 would include the location coordinates of the client device 3 at the time that the check-in communication is sent. That would be transmitted to the server 5 for validation or storage in respect of its related remote monitoring profile 27, and then the loop is shown to continue back to a reset on the time monitoring loop at step 10-2. When a new remote check-in frequency or time arrives, this would be triggered again. This Figure shows the client sidesteps that are involved in the capture, generation and transmission of remote check-ins in accordance with the method of the present invention.

At the server end, when a remote check-in communication is received by the server, it would be validated if required, and then stored to or in relation to the monitoring database 6, in relation to the related lone worker monitoring profiling 27.

As outlined above, there is really a two-way monitoring of remote check-ins possible in accordance with the method of the present invention. In a situation such as is shown in FIG. 10, where the software 20 on the client device 3 is responsible for triggering the assembly and transmission of remote check-ins, a first level of safety assurance is provided by virtue of the fact that the software 20 on the client device 3 can be programmed to escalate the urgency of the request to the user for the provision of the necessary input to trigger the remote check-in communication, and/or the software 20 on the client device 3 could actually trigger an immediate alert notification, in accordance with that data stream of the present invention, back to the server 5 if the remote check-in frequency was exceeded beyond tolerance to the point that safety was potentially threatened.

In addition to the fact that the software 20 on the client device 3 could trigger an escalated response or a response from the central server and monitoring station in accordance with the present invention if a remote check-in frequency was missed, at the server end, the details of remote check-in communications which are transmitted to the server and received there for storage in relation to their related lone worker monitoring profiles 27 can be monitored at the server end in accordance with or in conjunction with the remote check-in frequencies indicated in those profiles 27, such that at the server end, failure to meet a remote check-in frequency can also be identified, escalated and notified to the interface of the server in accordance with the remainder of the present invention.

As outlined elsewhere herein, the remote check-in frequencies could vary between individual lone worker monitoring profiles 27—it might be desired from an individual basis or even in respect of the particular types of jobs being undertaken by particular lone workers to have a longer or shorter remote check-in frequency set with respect to those jobs, roles or workers. A monitoring engine such as is contemplated in this invention would allow for identification and monitoring of these varied remote check-in frequencies, and the details of the programming of this monitoring loop and/or this aspect of the monitoring server software 5 and the client software 20 to accomplish this type of a monitoring approach or remote check-in approach will all be understood to be within the scope of the present invention.

### Immediate Alert Conditions:

The second type of a contemporaneous sensor or monitoring stream which is anticipated to take place within the scope of the present invention, in addition to the capture or administration of remote check-in responses, is the detection of potential escalation or notification at the central monitoring server interface of the existence of immediate alert conditions of one or more client devices 3 being monitored in accordance with the present invention. Immediate alert conditions might include such things as a fall or abrupt movement of the client device 3 etc.

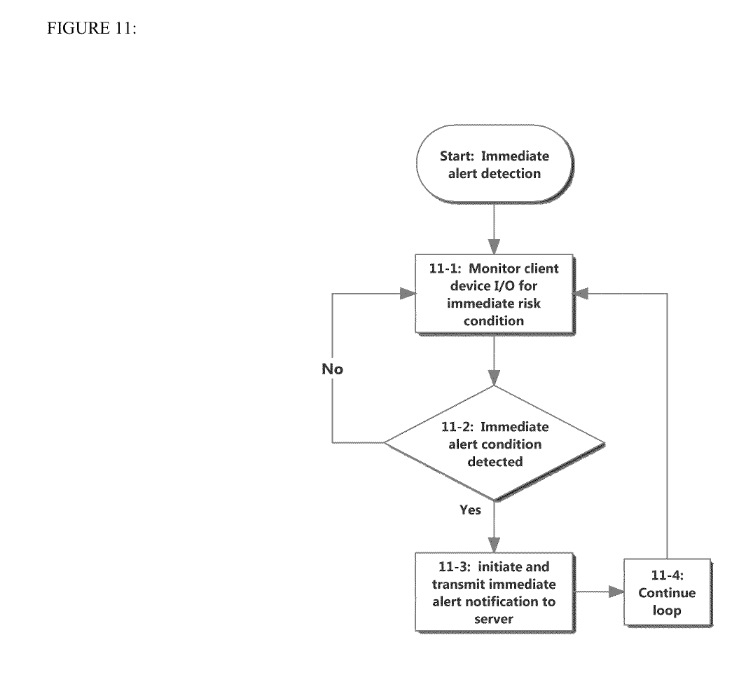

FIG. 11 is a flow chart demonstrating one illustrative embodiment of the Steps which would be undertaken by the software resident on the monitoring server 5 and the client device or devices 3 in accordance with the present invention to accomplish the immediate alert conditions monitoring and notification aspect of the present invention. Generally speaking what is contemplated here is that the lone worker device monitoring software 20 installed on the client device or devices 3 of the present invention would be capable of monitoring the sensors or other hardware on the client device 3 and detecting based on parameters stored therein the existence of immediate alert conditions.

The lone worker device monitoring software 20, as shown at Step 11-1, would monitor the hardware of the client device 3 to detect the existence of immediate alert conditions. A monitoring or decision block is shown at Step 11-2. If an immediate alert condition was determined or detected by the lone worker device monitoring software 20, the lone worker device monitoring software 20 would initiate and transmit an immediate alert notification to the monitoring server 5—shown at 11-3. The immediate alert notification would identify the client device of its origin or otherwise identify the lone worker in question. Following the transmission of the immediate alert notification to the monitoring server, the lone worker device monitoring software would continue its monitoring loop, shown at 11-4, seeking to detect any additional immediate alert conditions that the client device.

As in the case of the transmission of a remote check-in response outlined above, the data packet representing an immediate alert notification when transmitted to the monitoring server would identify the lone worker or the client device. It would also include the geo-coordinates of the client device 3 so that when a notification was generated at the user interface of the server notification of the user interface of the server could include the geo-referenced location of the client device in question for safety monitoring and notification purposes. The immediate alert detection of the method would work in parallel with the remote check-in prompting. As in the case of remote check-in prompting outlined above as well, the immediate alert notification transmission to the monitoring server with a received by the monitoring server for storage, monitoring and escalation or notification in accordance with subsequent Steps in the business method or workflow which are outlined in further detail below.

### Periodic Sensor Stream Data:

The third stream of information which would be captured from the client devices 3 in accordance with the present invention or communicated for storage at the monitoring server in coordination or conjunction with corresponding lone worker monitoring profile is a periodic sampling of sensor data from the hardware on the client device 3. The periodic sensor data which might be captured includes a periodic sampling of the location coordinates from the GPS or other geo-reference hardware on the device which could either be catalogued purely from the perspective of logging the location of the client device or could also be used for a periodic sampling against one or more geo-fences stored with respect to the lone worker monitoring profile in question at or accessible to the monitoring server. Other periodic sensor readings which could be captured include a battery power level or other calculations or sensor readings which it might be desired from time to time in accordance with particular implementations of the multistream monitoring method of the present invention to capture for monitoring and safety notification purposes.

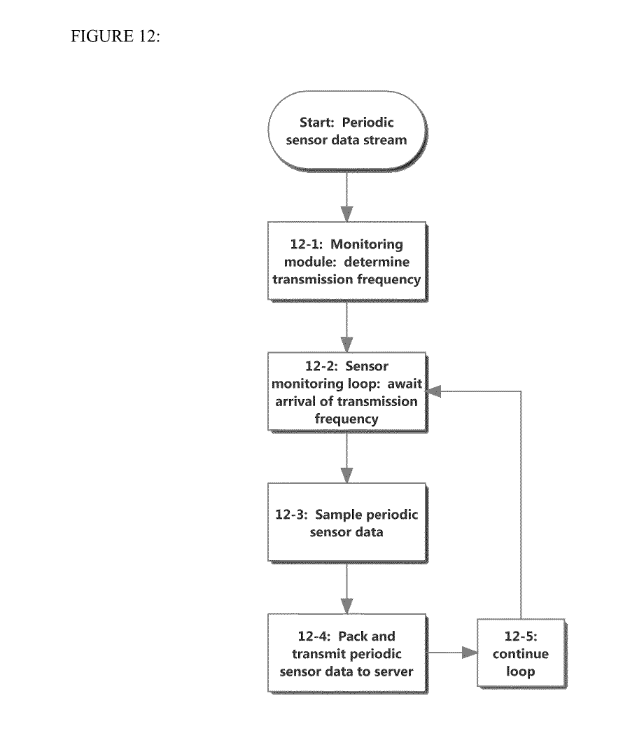

FIG. 12 is an illustrative flow chart showing the Steps in one periodic sensor data capture loop in accordance with the present invention. The lone worker device monitoring software installed upon the client device would first, shown at 12-1, determine the frequency within which it was to sample the various sensor data from the hardware of the client device and transmit that to the monitoring server for logging in conjunction with the associated lone worker monitoring profile. The transmission frequency could be ascertained either because it was hardcoded into the client software installed upon the client device 3, or the transmission or sampling frequency with respect to the capture of the periodic sensor data stream from the client device might be a parameters stored within the lone worker monitoring profile coordinated with that particular client device and stored within the monitoring database. Where the transmission or sampling frequency was a parameters stored within the lone worker monitoring profile, the client software installed upon the client device could access via the network connection between the client device and the monitoring server the lone worker monitoring profile parameters stored therein to download or otherwise capture or access that sampling or transmission frequency.

There is then shown in this Figure a sensor monitoring loop 12-2. Upon the arrival of each occurrence of the sampling or transmission frequency, a sample would be taken of the periodic sensor data which was desired to be transmitted to the monitoring server, shown at 12-3, and the data which was captured from the sensors on the client device for the periodic transmission thereof will be packed and transmitted to the monitoring server 12-4. The sensor monitoring loop would then continue 12-5 and repeat at its predetermined frequency. There are many different approaches which could be developed in terms of determining the transmission frequency for the capture of the periodic sensor data stream information, including even an adaptive transmission or sampling frequency based upon parameters captured. The capture and transmission of various sensor data from the hardware or hardware and software combination on various client devices to the monitoring server for storage in conjunction with the corresponding lone worker monitoring profile will be something understood to those skilled in the art of mobile device programming and all such implementations of this approach within the overall concept of the client or lone worker device monitoring software are contemplated within the scope of the present invention.

### Geo-Fences:

As outlined throughout this specification, the client devices 3 which are contemplated to be used in accordance with the method of the present invention are locationally aware—that is to say that they are each equipped with GPS or other triangulation or location determining technology, which will allow for the transmission from a client device 3 to the monitoring server 5 a locational geo-reference with respect to the client device 3 either at any time as a part of the periodic sensor stream data which is transmitted from the client devices 3 to the monitoring server 5 and the remainder of the system, or even as a geo-reference coordinate attached to any other type of a remote check-in response or other type of the data point transmitted from the client device 3. Streaming the geo-coordinates of the client device 3, or attaching the geo-coordinates to other data points captured for transmission, are both approaches contemplated herein. It is specifically contemplated that every transmission from a client device 3 in accordance with the invention to the server 5 will have a locational geo-reference attached to it.

Regardless of how the geo-coordinates of the client devices 3 are captured, with appropriate GIS or other software components resident upon or interacting with the remainder of the monitoring server 5 and the software therein, it will be possible to implement and monitor locational “geo-fences” with respect to client devices 3 and the lone workers associated therewith. The concept of geo-fencing will be understood to those skilled in the art of computer programming and GIS systems—effectively the locational coordinates of the client device 3 are compared to a computer-based map of geo-coordinates or locations, and if the location of a client device 3 is, upon such comparison determined to have moved outside of the acceptable or safe work area for example, a notification of the breach of the geo-fence could be escalated in accordance with the remainder of the present invention, as well as location-based warning or feedback could be transmitted back to the client device 3 by the monitoring server 5. By incorporating a geo-fencing aspect to the monitoring method of the present invention, the departure of lone workers with their client devices 3 from a safe work area or even just a predefined appropriate work territory could be monitored, logged and/or enforced. The specific nature of incorporating a location-based or geo-fencing type monitoring or notification aspect to the system of the present invention is contemplated within the scope hereof and the specific nature of the implementation required will be understood to those skilled in the art. All such necessary modifications to implement this type of a monitoring approach, in conjunction with user interface of the server notification such as is the case with the remainder of the notification types of the present invention, are contemplated within the scope hereof.

### Detecting Stop Movement:

Another specific type of monitoring and notification which is contemplated explicitly within the scope of the method of the present invention is the detection and notification of a cessation of movement of the client device 3. A prolonged period of no movement of a client device 3 within a presumed active timeframe is an indicator that there could be a safety risk or problem meritorious of notification or follow-up. It is explicitly contemplated that a stop movement condition could be determined on the basis of periodic sensor stream data transmitted to the monitoring server 5 for storage in the database 6 in conjunction with a lone worker monitoring profile. A prolonged stoppage of movement of a client device 3 associated with a lone worker monitoring profile in the monitoring database 6, once detected, would be notified to the user interface of the server again in accordance with the remainder of the present invention.

The primary means it is contemplated by which stop movement of the client device 3 would be detected would be by comparison at the monitoring server 5, by the software components therein, of chronologically adjacent geo-locations of the client device 3. For example if each time that a data point within the periodic sensor data stream is transmitted for storage in the database 6 that data point is accompanied by a timestamp and/or a geolocation of the client device 3, based upon the timestamps, if insufficient movement of the client device 3 in the determined time frame is calculated or detected, indicating either a safety exception or a condition otherwise meritorious of enterprise reporting or logging, a user interface of the server notification could be initiated in accordance with the notification programming and protocol of the remainder of the method of the present invention.

There will also be other means of calculating or determining a cessation of movement by a client device 3 which will be understood by those skilled in the art of mobile device and geolocation programming and the like. For example, the client software on the client device 3 might be programmed to only dispatch periodic sensor stream data to the monitoring server 5 for storage to the database 6 in accordance or conjunction with the corresponding lone worker monitoring profile if there is a change in the geolocation of the client device 3 between the predetermined data sample capture points. If the device has not moved, and as a result of which no location is transmitted, the failure to receive within a particular time frame or timestamp window and additional data point or packet indicating a change in the location of the device would be another detection or calculation method for a cessation of movement. It may even be possible to program the client software and client device 3 to simply detect on the basis of an onboard detection program a cessation of movement and to transmit that as an immediate alert condition in accordance with the remainder of the present invention—any number of different types of detection or calculation of the cessation of movement by client device 3 will be understood by those skilled in the art and are all contemplated within the scope hereof.

Stop movement of a client device 3 could either be detected as a periodic sensor data stream monitoring task, or detection of stop movement at the device could also be programmed into a lone worker monitoring profile 27 as an immediate alert condition. Both such approaches are contemplated within the scope of the present invention.

### Detecting Fall or Abrupt Movement:

An additional safety condition which it is desired at the highest level to incorporate into the method of the present invention is the detection of a fall or an abrupt movement by the client device. A fall or other type of abrupt movement by a client device 3 can be interpreted from a monitoring perspective as an indicator of the possibility of a safety threat or risk and on that basis if a fall or abrupt movement outside of a predetermined or programmed acceptable parameter window was detected it would be appropriate to escalate as in accordance with the notification program of the present method and invention to the central monitor or administrator of the monitoring server end the system of the present invention for follow-up.

There will be many different ways of determining a fall or abrupt movement of the client device 3. The primary basis on which it is anticipated that this type of a detection functionality would be added to the client software installed upon the client device 3 would be to obtain data indicating a fall or abrupt movement from the accelerometer, gyroscope or other similar sensor resident thereon. Those skilled in the art of sensor technology, mobile devices and programming therefore will understand the different aspects or possibilities that exist for the programming of the client software and the mobile device in conjunction with the accelerometer or similar sensor thereon, and any such data capture method, resulting in the ability to detect and/or report if an immediate alert condition is determined to exist, the occurrence of a fall or abrupt movement of the client device to the monitoring server 5 for monitoring and potential modification in accordance with the remainder of the method of the present invention are all contemplated within the scope hereof.

As in the case of the detection of a cessation of movement of the client device, outlined above, detection of a fall or abrupt movement is also determined to be a key element of the safety notification and detection method of the present invention at its highest level in addition to the detection of a failure to provide a timely remote check-in response, cessation of movement of the client device, or detection of a fall or abrupt movement thereof.

Abrupt fall or movement of a client device 3 could either be detected as a periodic sensor data stream monitoring task, or detection of stop movement at the device could also be programmed into a lone worker monitoring profile 27 as an immediate alert condition. Both such approaches are contemplated within the scope of the present invention.

### Listening and Notification:

As shown in FIGS. 10 through 12, there are at least three separate streams of data which would be transmitted from client devices 3 in accordance with the present invention to the monitoring server for storage in conjunction with their corresponding lone worker monitoring profiles and the monitoring database. These include the responses to remote check-in prompts, immediate alert condition notifications and periodic sensor data stream information.

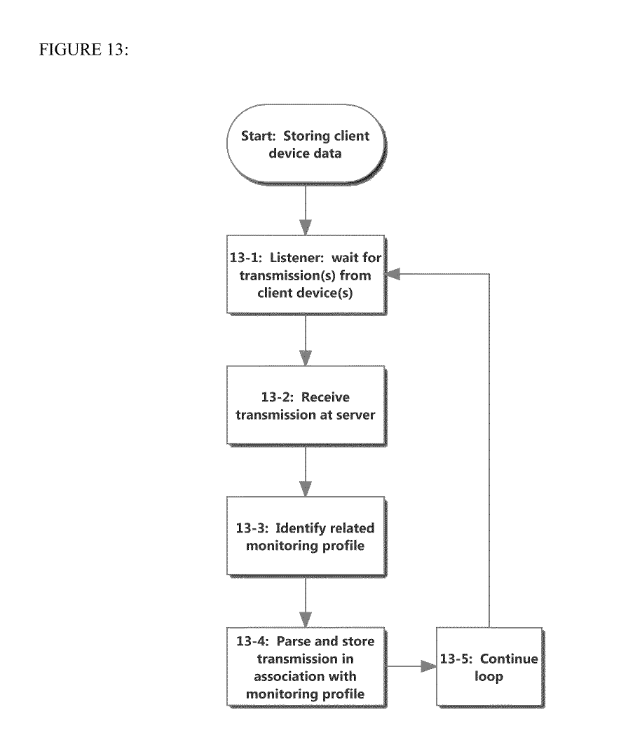

One monitoring server level step which will be conducted by the software resident on the monitoring server method of the present invention is the receipt and storage of any data transmissions from client devices on the network. Referring to FIG. 13, there is shown a flow chart of one example of a basic flow for the software installed upon the monitoring server to receive and store client device data. Shown at Step 13-1 is a listening step—a listener or agent, as will be understood to those skilled in the art of client/monitoring server programming and network communications, will wait for a transmission or transmissions from one or more client devices 3 in accordance with the remainder of the system and method of the present invention. If a transmission is received at the monitoring server 5, shown in this case at Step 13-2, the first thing that would need to be done with respect to the transmission would be to identify the related lone worker monitoring profile 27 therefore. This is shown at Step 13-3. For example, the transmission which was received could be identified and correlated to the proper lone worker monitoring profile 27 within the monitoring database 6 by matching the network address or other identifying information on the packet or packets received in the transmission by the monitoring server 5 from the client device 3.

Upon identifying the related lone worker monitoring profile 27, the transmission which was received by the monitoring server could be parsed as required and stored in association with the identified related lone worker monitoring profile 27 in or in conjunction with the monitoring database—shown at Step 13-4. Part of parsing for storage the transmission received may also be to identify the type of client device data which has been received i.e. if it is a remote check-in, a periodic sensor data transmission or a notification of an immediate alert condition. The proper identification of the information contained within the transmission received and the correlation thereof with the appropriate lone worker monitoring profile 27 in the monitoring database 6 will be steps the specifics of details which will be understandable to those skilled in the art of network communications and client/monitoring server computer programming and again all such approaches are contemplated within the scope hereof.

Shown at Step 13-5 is the continuation of the listening loop shown in this Figure. Again the development of an agent or listener which is capable of in a continuous fashion monitoring the network interface of the monitoring server to receive and process transmissions of client device data received from client devices 3 in accordance with the remainder of the method of the present invention will be something that can be developed based in the knowledge of those skilled in the art of computer programming and all approaches which are taken to the development of this overall method are again considered to be within the scope hereof.

The Figures and disclosure herein demonstrate the generation and transmission of client device data transmission or packets as separate processes from the receipt, parsing and storage of those packets at the monitoring server. It will however be understood that the steps could be implemented in various more consolidated or segregated ways, by those skilled in the art of client/monitoring server programming.

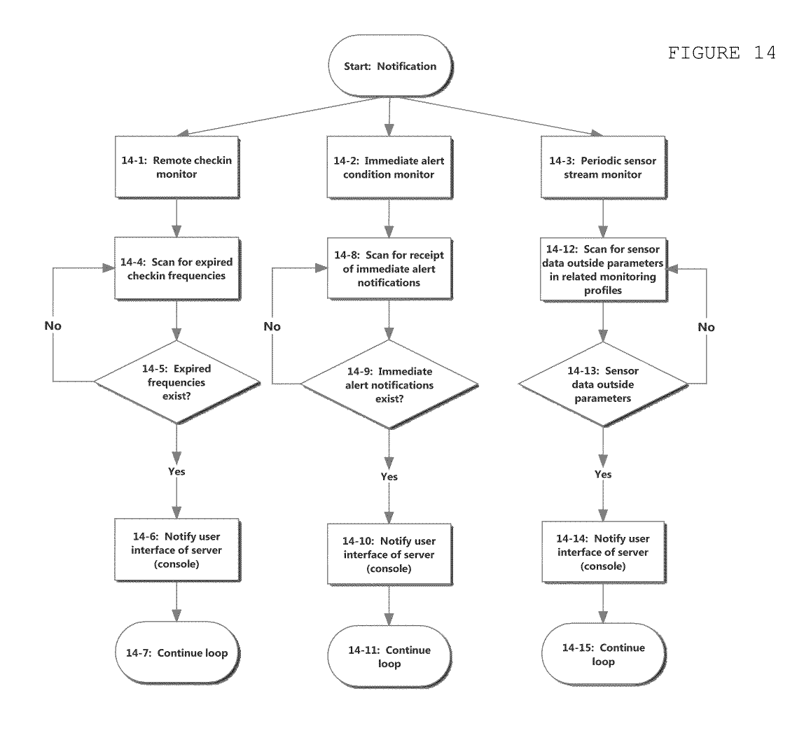

FIG. 13 shows the capture and storage of client device data transmitted from client devices in accordance with the remainder of the system and method of the present invention. Moving on to FIG. 14 there is shown the final aspect of the lone worker monitoring method of the present invention which is the actual monitoring and notification aspect of the invention based upon client device data which is captured and stored upon its receipt from the client devices.

FIG. 14 shows the steps involved in monitoring the three streams of data which will be received from client devices 3 in accordance with the method of the present invention. The three monitoring streams are shown in this Figure in parallel, for the sake of demonstrating the slightly different series of monitoring steps associated with each type of data stream, although it will also be understood that for those skilled in the art of database programming a single monitoring routine or a single monitoring flow chart and loop could be designed which would accomplish the same objective.

The three streams of data capture and monitoring which are shown in this Figure are a remote check-in monitoring stream, shown at 14-1, monitoring of immediate alert condition notifications 14-2, and monitoring of periodic sensor stream data received and stored in accordance with the invention 14-3.

Referring to FIG. 14 and the remote check-in monitoring stream, the notification agent or other components of the software on the monitoring server would scan the log of remote check-in communications to identify any expired remote check-in frequencies in respect of which a remote check-in response had not been received. That decision block shown at 14-5 represents this test or logic. If no expired remote check-in frequencies existed, the remote check-in monitoring stream would simply continue its monitoring loop until such time as any expired time limits did exist. If on the other hand it was determined that one or more expired frequencies existed, meaning that one or more client devices had not sent a remote check-in within the prescribed time, the user interface of the server and operator of the monitoring server would be notified, shown at 14-6. Alternatively or additionally it may be the case that additional notification parameters could be specified with respect to a particular lone worker monitoring profile 27 and additional notification or dispatch could be effected based upon the detection of an expired remote check-in prompt as well. Following provision of notification regarding the expiry of a check-in frequency without a proper response being received to the user and the user interface of the server the monitoring server—which as outlined elsewhere herein could either be by way of a local hardware and software interface or even by way of a separate client/monitoring server, intranet or website interface—the remote check-in monitoring loop could be continued 14-7.

In parallel to the monitoring of remote check-in frequencies to ascertain whether or not any remote check-ins had failed to be made by the lone workers and their client devices, the second monitoring stream which is shown in this Figure is the immediate alert condition monitoring stream, shown downstream at Step 14-2. As outlined elsewhere above, upon the detection of immediate alert condition at the client device, the client software at the client device would prepare and transmit an immediate alert notification to the monitoring server for storage to the monitoring database associated with the lone worker monitoring profile therefore. Then, shown at Steps 14-8 and 14-9 is a scanning or monitoring loop within which the data received from client devices and stored on the monitoring server in accordance with the remainder of the method of the present invention would be scanned and monitored to identify any immediate alert condition notifications have been received and/or not yet actioned. If no immediate alert notifications have been received this particular monitoring loop could simply continue. If an immediate alert notification was determined to exist in the database or in storage in the monitoring server which had not yet been escalated or notified, a user interface of the server modification of that immediate alert notification would be triggered 14-10, and the immediate alert condition monitoring loop could then continue, as shown at 14-11.

The final monitoring stream which is shown in this Figure is the periodic sensor monitoring stream, shown downstream of block 14-3. As outlined elsewhere herein, the lone worker monitoring profiles 27 stored within the monitoring database with respect to particular pairings among workers and client devices could include periodic sensor data parameters outside of which it was desired to provide a notification to the user interface of the server and monitoring server in accordance with the remainder of the method of the present invention. The periodic sensor monitoring could include capturing periodic location fixes on the client device 3 for comparison with one or more geo-fences stored within the monitoring server, or other sensor parameters which were desired to be checked and verified from time to time. Shown at Steps 14-12 and 14-13 are the periodic sensor data received from client devices and stored, to identify any periodic sensor data capture which exceeds the parameters set—if any such deviation is detected, a user interface of the server modification is shown at 14-14, and the monitoring loop again continues.

This Figure shows the user interface of the server notification in respect of each of the three monitoring streams as a separate process although it will also be understood by those skilled in the art of computer programming and business methods such as this that a single consolidated notification step could also be created which would deal with the notification to the user interface of the server of the monitoring server of any exception detected with respect to any of the three monitoring streams, and either such approach is contemplated within the scope of the present invention.

As outlined elsewhere herein one of the key distinguishing factors of the present invention over the prior art is the fact that it is explicitly contemplated that the user interface of the server of the monitoring server will be used both for the purpose of configuring or accessing the lone worker monitoring profiles created for each pairing of a client device and the lone worker, as well as for notification of a detected exception in the various safety monitoring streams herein. The location of a client device 3 will always be provided with every data set captured to the server also, so that the location of the client device 3 at the time of generation of the data will be known and can be provided in the server notifications.

The foregoing has described the novel method and system for centrally monitored and administered lone worker safety monitoring of the present invention. While specific embodiments of the present invention have been described, it will be apparent to those skilled in the art that various modifications thereto can be made without departing from the spirit and scope of the invention. Accordingly, the foregoing description of the preferred embodiments of the invention and the best mode for practicing the invention are provided for the purpose of illustration only and not for the purpose of limitation.

We claim:

1. A method of central lone worker monitoring using a monitoring server operatively connected for two way communication via a data network with a plurality of locationally-aware mobile client devices each associated with a lone worker, said method comprising:
a. providing a monitoring database connected to the monitoring server which contains at least one lone worker monitoring profile corresponding to a lone worker to be monitored and their associated client device, each lone worker monitoring profile containing at least:
i. identification of the lone worker and associated client device;
ii. a designated remote check-in frequency for the associated client device;
iii. details of periodic sensor stream data to be captured and stored in respect of the associated client device;
iv. periodic sensor stream parameters, detection of the departure from which should result in notification to the operator of the monitoring server; and
v. details of immediate alert conditions which should be detected by the associated client device, upon detection of the existence of which immediate notification should be transmitted to the monitoring server;
b. providing lone worker device monitoring software on each client device, in communication with the monitoring server and the monitoring database via the network, said lone worker device monitoring software capable of:
i. accessing and interacting with the lone worker monitoring profile associated with the client device;
ii. transmitting remote check-in communications from the client device to the monitoring server, based on the remote check-in frequency in the lone worker monitoring profile;
iii. capturing periodic sensor stream data on the client device identified in the corresponding lone worker monitoring profile, and transmitting same to the monitoring server periodically; and
iv. detecting the existence of any immediate alert conditions identified in the associated lone worker monitoring profile and transmitting notification of same to the monitoring server;
wherein every transmission from the client device to the monitoring server includes the location coordinates of the client device;
c. providing interface software on the monitoring server, operatively connected to the monitoring database, which will:
i. in conjunction with a user interface of the monitoring server:
1. allow for the creation and modification of lone worker monitoring profiles in the monitoring database; and
2. allow for notification to the operator of the monitoring server of the existence of any detected alert conditions in respect of lone workers being monitored;
ii. receive the following types of client data transmissions from client devices on the network and storing details of those client data transmissions, being stored client device data, in the monitoring database in association with their corresponding lone worker monitoring profile:
1. remote check-in communications;
2. periodic sensor stream data transmissions; or
3. immediate alert condition notifications;
d. during operation of a lone worker monitoring loop, using the interface software on the monitoring server:
i. scanning remote check-in communications stored within the stored client device data in the monitoring database to detect any failure of a client device to transmit a remote check-in within the designated remote check-in frequency and upon the detection of any such failure providing an alert to the user interface of the monitoring server;
ii. scanning periodic sensor stream data stored within the stored client device data in the monitoring database to detect any departure of any of the periodic sensor stream data in respect of its client device from any periodic sensor stream parameters stored within the lone worker monitoring profile, and upon detection of any such departure providing an alert to the user interface of the monitoring server;
iii. scanning the stored client device data in the monitoring database for any immediate alert condition notifications in respect of a monitored client device, and upon detection of any previously unnotified immediate alert condition notifications providing an alert to the operator of the user interface of the monitoring server.

2. The method of claim 1 further comprising initiation of communication between the monitoring server and the client device when the user interface of the monitoring server receives an alert notification.

3. The method of claim 2 wherein the client device and the monitoring server both contain audio communication hardware and software, and wherein upon provision of an alert notification to the user interface of the monitoring server based on stored client device data, an audio communication channel is opened between the client device and the user interface of the monitoring server.

4. The method of claim 1 wherein the periodic sensor stream data captured from at least one client device includes the battery power level of the client device.

5. The method of claim 1 wherein remote check-in communications are transmitted from the client device to the monitoring server based on a preset frequency.

6. The method of claim 1 wherein remote check-in communications are transmitted from the client device to the monitoring server in response to a network request from the monitoring server to send such a communication.

7. The method of claim 1 wherein the immediate alert conditions which are stored in respect of a lone worker monitoring profile and the existence of which should be detected and notified to the monitoring server are one or more of the following:
a. a fall of the client device;
b. abrupt movement of the client device;
c. cessation of movement of the client device;
d. movement of the client device outside of a predefined working area;

8. The method of claim 7 where the cessation of movement by a client device is determined by either:
a. comparing chronologically adjacent location coordinate and time stamp pairings; or
b. determining that accelerometer readings from the client device indicate no movement.

9. The method of claim 7 wherein the fall or abrupt movement of the client device is determined by detection of a rapid movement by the accelerometer on the client device.

10. The method of claim 7 wherein movement of the client device outside of a predefined working area is determined by the comparison of the location coordinates captured in respect of the client device with one or more geo-fences associated with the associated lone worker monitoring profile.

11. The method of claim 1 wherein the lone worker device monitoring software further comprises a manual emergency notification function, wherein the lone worker of the client device could manually trigger an immediate alert condition notification to the monitoring server.

12. The method of claim 1 wherein the operator of the monitoring server can send messages to the user interface of one or more client devices during the lone worker monitoring loop.

13. A computer implemented method comprising under control of one or more computer systems configured with executable instructions:
a. providing a monitoring database which can be administered from a user interface of a central monitoring server, which contains at least one lone worker monitoring profile associated with a lone worker to be monitored and their corresponding locationally-aware client device, the lone worker monitoring profile containing at least:
i. identification of the lone worker and associated client device;
ii. a designated remote check-in frequency for the associated client device;
iii. details of periodic sensor stream data to be captured and stored in respect of the associated client device;
iv. periodic sensor stream parameters, detection of the departure from which should result in notification to the operator of the monitoring server;
v. details of immediate alert conditions which should be detected by the associated client device, upon detection of the existence of which immediate notification should be transmitted to the monitoring server;
wherein every transmission from a client device to the monitoring server includes the location coordinates of the client device;
b. on a client device corresponding to a lone worker monitoring profile, detecting that the designated remote check-in frequency has been reached and transmitting a remote check-in communication to the server for storage in association with the lone worker monitoring profile;
c. on a client device corresponding to a lone worker monitoring profile, capturing periodic sensor stream data and transmitting said sensor stream data to the monitoring server for storage in association with the related lone worker monitoring profile;
d. on a client device corresponding to a lone worker monitoring profile, detecting the existence of any immediate alert conditions contained within the corresponding lone worker monitoring profile and transmitting details of same from the client device to the monitoring server for storage in association with the related lone worker monitoring profile;
e. using monitoring software on the central monitoring server, monitoring the details of stored client device data stored in the monitoring database and upon detection of any of the following conditions notifying the operator of the monitoring server via the user interface:
i. failure of a client device to respond to provide a timely remote check-in communication;
ii. detection of any previously unnotified immediate alert condition at a client device; or
iii. detection of the departure of periodic sensor stream data received from a client device from any periodic sensor stream data parameters specified in the associated lone worker monitoring profile.

14. The method of claim 13 wherein the immediate alert conditions which are stored in respect of a lone worker monitoring profile and the existence of which should be detected and notified to the monitoring server are one or more of the following:
a. a fall of the client device;
b. abrupt movement of the client device;
c. cessation of movement of the client device;
d. movement of the client device outside of a predefined working area;

15. The method of claim 14 where the cessation of movement by a client device is determined by either:
a. comparing chronologically adjacent location coordinate and time stamp pairings; or
b. determining that accelerometer readings from the client device indicate no movement.

16. The method of claim 14 wherein the fall or abrupt movement of the client device is determined by detection of a rapid movement by the accelerometer on the client device.

17. The method of claim 14 wherein movement of the client device outside of a predefined working area is determined by the comparison of the location coordinates captured in respect of the client device with one or more geo-fences associated with the associated lone worker monitoring profile.

18. The method of claim 13 further comprising providing a user interface on a client device through which a lone worker could indicate an immediate alert condition for transmission to the monitoring server for handling in association with the associated lone worker monitoring profile.

19. One or more computer readable storage media storing computer executable instructions that, when executed by one or more processors, instruct a computing device to perform acts comprising:
a. providing a user interface on a monitoring server through which human operators can create and administer lone worker monitoring profiles in a monitoring database, each lone worker monitoring profile containing at least:
i. identification of the lone worker and associated client device;
ii. a designated remote check-in frequency for the associated client device;
iii. details of periodic sensor stream data to be captured and stored in respect of the associated client device;
iv. periodic sensor stream parameters, detection of the departure from which should result in notification to the operator of the monitoring server;
v. details of immediate alert conditions which should be detected by the associated client device, upon detection of the existence of which immediate notification should be transmitted to the monitoring server;
b. receive the following types of client data transmissions from client devices on the network and storing details of those client data transmissions, being stored client device data, in the monitoring database in association with their corresponding lone worker monitoring profile:
i. remote check-in communications;
ii. periodic sensor stream data transmissions; or
iii. immediate alert condition notifications;
c. notifying the operator of the user interface of the server upon detection of any of the following conditions with respect to a client device:
i. failure of a client device to transmit a remote check-in within the designated remote check-in frequency;
ii. departure of any of the periodic sensor stream data in respect of its client device from any periodic sensor stream parameters stored within the lone worker monitoring profile; or
iii. detection of any immediate alert condition notifications received from the client device;
wherein the lone worker monitoring profiles in respect of the client devices are controlled and administered only by the user interface of the server.

20. The method of claim 19 wherein the immediate alert conditions which are stored in respect of a lone worker monitoring profile and the existence of which should be detected and notified to the monitoring server are one or more of the following:
a. a fall of the client device;
b. abrupt movement of the client device;
c. cessation of movement of the client device;
d. movement of the client device outside of a predefined working area;

21. The method of claim 20 where the cessation of movement by a client device is determined by either:
a. comparing chronologically adjacent location coordinate and time stamp pairings; or
b. determining that accelerometer readings from the client device indicate no movement.

22. The method of claim 20 wherein the fall or abrupt movement of the client device is determined by detection of a rapid movement by the accelerometer on the client device.

23. The method of claim 20 wherein movement of the client device outside of a predefined working area is determined by the comparison of the location coordinates captured in respect of the client device with one or more geo-fences associated with the associated lone worker monitoring profile.

24. A monitoring server capable of two-way communication with a plurality of locationally-aware mobile client devices of lone workers over a data network, said monitoring server having:
a. a monitoring database therein containing a plurality of lone worker monitoring profiles each associated with the client device of a monitored lone worker, each lone worker monitoring profile containing at least:
i. identification of the lone worker and associated client device;
ii. a designated remote check-in frequency for the associated client device;
iii. details of periodic sensor stream data to be captured and stored in respect of the associated client device;
iv. periodic sensor stream parameters, detection of the departure from which should result in notification to the operator of the monitoring server;
v. details of immediate alert conditions which should be detected by the associated client device, upon detection of the existence of which immediate notification should be transmitted to the monitoring server; and
b. an interface software program adapted to be executed by said monitoring server, wherein said program will:
i. continuously scan the lone worker monitoring profiles stored within the monitoring database and upon detection of the arrival of the check-in time for a particular lone worker monitoring profile based upon the stored check-in frequency for remote check-in, transmit a remote check-in request to the associated client device;
ii. receive the following types of client data transmissions from client devices on the network and storing details of those client data transmissions, being stored client device data, in the monitoring database in association with their corresponding lone worker monitoring profile:
1. remote check-in communications;
2. periodic sensor stream data transmissions; or
3. immediate alert condition notifications;
iii. during operation of a lone worker monitoring loop:
1. scan remote check-in communications stored within the stored client device data in the monitoring database to detect any failure of a client device to transmit a remote check-in within the designated remote check-in frequency and upon the detection of any such failure provide an alert to the user interface of the monitoring server;
2. scan periodic sensor stream data stored within the stored client device data in the monitoring database to detect any departure of any of the periodic sensor stream data in respect of its client device from any periodic sensor stream parameters stored within the lone worker monitoring profile, and upon detection of any such departure provide an alert to the user interface of the monitoring server; and
3. scan the stored client device data in the monitoring database for any immediate alert condition notifications in respect of a monitored client device, and upon detection of any previously unnotified immediate alert condition notifications provide an alert to the operator of the user interface of the monitoring server.
